(19) United States
(12) Patent Application Publication
(10) Pub. No.: US 2024/0222674 A1
(43) Pub. Date: Jul. 4, 2024

(54) Aqueous Energy Storage System For Redox Flow Batteries

(71) Applicant: CMBlu Energy AG, Alzenau (DE)

(72) Inventors: Peter GEIGLE, Alzenau (DE); Nils WEDLER, Ladenburg (DE); Evgeny LARIONOV, Hanau (DE); Eduard BAAL, Offenbach (DE); Nis-Julian KNEUSELS, Mainhausen (DE); Christian SCHNEIDER, Aschaffenburg (DE); Olga EKKERT, Hanau (DE); Markus Richard HARTMANN, Seligenstadt (DE); Doris NEUMANN, Offenbach (DE); Michael UN-KRIG-BAU, Alzenau (DE)

(21) Appl. No.: 18/038,820

(22) PCT Filed: Dec. 24, 2021
(86) PCT No.: PCT/EP2021/087647

§ 371 Date: May 25, 2023

(30) Foreign Application Priority Data
Dec. 24, 2020 (WO) PCT/EP2020/087871

(51) Int. Cl. H01M 8/18

(52) U.S. Cl. CPC H01M 8/188; H01M 2250/10; H01M 2300/0014

(57) ABSTRACT

The present invention relates to an aqueous energy storage system, comprising a half-cell containing an aqueous solution of at least two redox-active compounds (RACs) and one or more insoluble preferably organic energy storage material(s). Moreover, the use of such a half-cell as negative electrode in redox-flow battery application is described.

The present invention relates to an aqueous energy storage system, comprising a half-cell containing an aqueous solution of at least two redox-active compounds (RACs) and one or more insoluble preferably organic energy storage material(s). Moreover, the use of such a half-cell as negative electrode in redox-flow battery application is described.

Recently, environmental concerns regarding the use of fossil fuels as the main energy source have led to an increasing demand for renewable energy sources (e.g., solar- and wind-based systems). Due to the natural discontinuity of renewable energy sources, difficulties emerge regarding their integration into electrical power grids and distribution networks. Such issues are addressed by large-scale electrical energy storage (EES) systems, which also are vital for smart grids and decentralized electricity generation. (G. L. Soloveichik, Chem. Rev. 2015, 115, 11533-11558).

Redox-flow batteries (RFBs) belong to the most promising scalable EES technologies known as of today. RFBs are electrochemical systems that can store and convert electrical energy to chemical energy and vice versa when needed. Their energy converting unit consist of two compartments, which are in contact via an ion-exchange membrane and each contains at least one electrode and a solution of a redox-active compound (RAC) (electrolyte). The electrolytes are commonly stored in containers outside the energy converting unit and pumped through the energy converting unit under operational conditions.

To charge RFBs, the RAC at the anode side of the energy storage system is electrochemically reduced and the other RAC at the cathode side is electrochemically oxidized at the respective electrode generating a potential difference. The above redox reactions are inversed when discharging the battery. Thereby, the electrical energy is stored exclusively by the dissolved RACs decoupling the key battery characteristics, i.e. power (current) and energy (capacity). While an increase in energy can be achieved by using larger electrolyte volumes, larger or more energy converting units may be employed for higher power output. Consequently, the performance of RFBs can be adapted to the individual operational needs making them suitable EES for a broader variety of applications.

However, a common challenge of all conventional redox-flow batteries to date is their upscaling for storage of large energy amounts. With dissolved compounds as the sole energy storage source, enormous electrolyte solution volumes are required, which is associated with shortcomings concerning the abundance of the RACs. Dissolved RACs in RFBs typically low volumetric energy density compared to other battery types

In view thereof, a novel design for redox-flow batteries is envisaged by WO 2013/012391 A1 and by EP 3 316 375 B1. According to that novel design, a solid, insoluble energy storage material is placed inside the electrolyte tank. A single dissolved RAC is applied as a charge carrier or shuttle between the electrode and the insoluble energy storage material only, while the electric energy is stored by the solid material. That design is known as “redox-targeting approach”.

Typically, energy density of solid energy storage materials is significantly higher than the energy density of dissolved species. Redox-targeting RFBs thus offer significantly higher capacities than conventional RFBs without increase of the applied electrolyte volumes and concentrations of dissolved RACs. However, in order to design a functional redox-targeting electrolyte system according to the aforementioned approach, the redox-potentials of the RAC and the solid energy storage material have to be selected appropriately.

Various publications (E. Zanzola et al., Electrochimica Acta 2017, 664., J. Yu et al. ACS Energy Let. 2018, 3, 2314, and M. Zhou, Angew. Chem. Int. Ed. 2020, 59, 14286) describe “one carrier one solid” redox-targeting systems with the redox-active species being dissolved in aqueous solutions. Zanzola et al. and Yu et al. utilize transition metal compounds as RACs or solid material, respectively. Zhou et al. focus on a specific combination of an anthraquinone derivative as redox-active species and an polyimide as solid deposit material enabling a functional redox-targeting RFB.

A more versatile approach to exploit high capacity solid energy storage materials is described by U.S. Pat. Nos. 9,548,509 B2, 9,859,583 B2 and US 2020/028197 A1. By that approach, two distinct soluble RAC species are employed by the half-cell. Their redox-potentials frame the redox-potential of the solid energy storage material. Their non-aqueous electrolyte solutions are disadvantageous, e.g. due to their components' toxicity and fire hazard.

It is an object of the present invention to provide an operationally safe high energy storage electrolyte system based on a redox-targeting redox-flow battery. The present invention uses preferably organic compounds as dissolved RACs and as solid energy storage materials, which are readily available. The inventive system is non-flamable by the aqueous nature of the electrolyte solutions. A larger variety of solid energy storage materials can be employed, making the inventive design highly flexible and adaptable. The present invention provides for a safe, versatile electrolyte system based on an aqueous solution exploiting a high energy density for use in redox-flow batteries.

The present invention provides a composition comprising an aqueous solution of at least two redox-active preferably organic compounds RAC1 and RAC2 and at least one insoluble energy storage material. Insoluble means that the amount of dissolved material is very minor as compared to the undissolved material, e.g. lower than 0.5% (by weight) or lower than 0.05% by weight. The use of two or at least two redox-active compounds (RAC1 and RAC2) in the aqueous electrolyte solution provides the advantage that the concentration of each of these compounds may be reduced as compared to the one shuttle system. According to the present invention, the redox potential of RAC1 is more negative than the redox potential of the insoluble energy storage material (IESM). The redox potential of RAC2 is more positive (or, typically, less negative) than the redox potential of the insoluble energy storage material. In other words: If the redox potential of the insoluble energy storage material is negative (e.g. −0.4 V), the redox potential of RAC1 is smaller (more negative) than the redox potential of the insoluble energy storage material (e.g. −0.5 V). The redox potential of RAC2 is larger (more positive), typically less negative than the redox potential of the insoluble energy storage material (e.g. −0.3 V). Thus, the following typically holds: E_{RAC1}<E_{IESM}<E_{RAC2} (E: redox potential, typically defined by V (Volt).

Preferably, the insoluble energy storage material is an insoluble organic energy storage material.

The difference of the redox potential of RAC1 and RAC2, respectively, is typically at least 50 mV. Preferably, the difference of the redox potential of RAC1 and the insoluble (organic or inorganic) energy storage material is at least 25 mV, more preferably at least 40, 50, 60 or 70 mV. The difference of the redox potential of RAC2 and the insoluble (organic or inorganic) energy storage material is preferably at least 25 mV, more preferably at least 40, 50, 60 or 70 mV. According to one preferred embodiment, the difference of the redox potential of RAC1 and the insoluble (organic) energy storage material is at least 50 mV and/or the difference of the redox potential of RAC2 and the insoluble (organic or inorganic) energy storage material is at least 50 mV. According to another preferred embodiment, the difference of the redox potential of RAC1 and RAC2, respectively, on the one hand and the insoluble (organic or inorganic) energy storage material on the other hand is at least 50 mV in both instances.

As energy loss results from redox potentials of the RACs of significant difference, the difference of the redox potential of RAC1 and RAC2 is typically less than 600 mV, preferably less than 500, less than 400 or less than 300 mV. Depending on the envisaged application, the difference of the redox potential of RAC1 and RAC2 may alternatively also be less than 200 mV or less than 100 mV.

The redox potential of the insoluble (organic or inorganic) energy storage material is required to fall within the window defined by the redox potentials of RAC1 and RAC2. Preferably, the insoluble (organic) energy storage material has a redox potentially which is equally distant (equidistant) from the redox potential of both RAC1 and RAC2. A narrow window defined by RAC1 and RAC2 thus limits the number of (organic) insoluble energy storage materials, which exhibit a redox potential falling within such a narrow window.

An exemplary process of charging and discharging energy is described in the following:

When storing (charging reaction) electrical energy by the redox flow battery, RAC1 is reduced at the anode of the anodic half-cell of a redox flow battery to its reduced form (RAC1_{red}). RAC1_{red} is circulated via a circuit (and its pump) to an external container that contains the insoluble (organic) energy storage material (IOESM). IOESM is reduced to its reduced state (IOESM_{red}) by RAC1_{red}'s electron transfer to IOESM. By that charger transfer, RAC1_{red} is converted to RAC1 (oxidized state). RAC1 circulates back to the anode chamber where it is again reduced to RAC1_{red}. The reaction cycle is reiterated.

For discharging the battery, the following reaction takes place at the anodic half-cell: RAC2 circulates to the container where it is reduced by IOESM_{red} to its reduced form, (RAC2_{red}). RAC2_{red} is pumped to the anode chamber where it is oxidized to form RAC2 and the reduction/oxidation cycle restarts again.

RAC1 and RAC2 are both dissolved in the same aqueous electrolyte solution and circulate both through circuit of the (anodic) half-cell of the RFB.

RAC1 and RAC2 act as shuttle compounds to transfer charge to and from the insoluble (organic) energy storage material being the charge depot of higher energy density. The use of redox-active species as shuttle compounds provides various advantages: First, the provision of shuttle compounds allows the energy storage material to be stored in an external tank. Thus, it is not transported from the external storage tank to the electrochemical cell and vice versa. Second, the energy storage materials as solids may be retained in the tank, e.g. in a densely packed bed arrangement, allowing for control of the electrode properties preferably without the use of conductive additives or binders. Thereby, a higher energy density, and improved battery performance is achieved. Third, the inventive approach does not require the energy-consuming step of pumping high viscosity energy storage materials through the circuit.

The insoluble (organic or inorganic) energy storage material as a solid material is stored in the tank e.g. in the form of a powder. Alternatively, the insoluble (organic or inorganic) energy storage material may be compounded with e.g., a binder (e.g., polyvinylidene difluoride) and/or an auxiliary material (e.g., carbon black and/or multi-walled carbon nanotubes).

According to the present invention, also a combination of two or more insoluble energy storage materials can be used. For example, a combination of two or more insoluble organic or inorganic energy storage materials or a combination of at least one insoluble organic or inorganic energy storage material with at least one insoluble inorganic energy storage material or a combination of two or more insoluble inorganic energy storage materials.

Examples for inorganic energy storage materials are compounds containing iron, manganese, cobalt or lithium (e.g., LifePO₄, LiCoO₂ and LiMnO₂); compounds containing vanadium (e.g., V₂O₅); and compounds containing titanium, niobium, or lithium (e.g., Li₄Ti₅O₁₂ and LiNbO₃). An inorganic energy storage material may e.g. be a material which is capable of reversibly occluding and releasing alkali metal ions or alkaline earth metal ions, such as transition metal oxides, fluorides, polyanions, fluorinated polyanions, and transition metal sulfides.

If a combination of two or more insoluble energy storage materials is used, the different insoluble energy storage materials may e.g. be selected such that one of them is kinetically inert, but provides for a high energy density, while the other one reacts kinetically fast, but provides for a low energy density.

As mentioned above, the insoluble (organic) energy storage material is the charge depot. In the following, the insoluble (organic) energy storage material is also called “depot” or “depot material”.

The concentration of the shuttle compound RAC1 and RAC2 in the half-cell's electrolyte solution determines the overall battery efficiency. In an embodiment, RAC1 and RAC2 are provided approximately in equal amounts in the system's (half-cell's) electrolyte solution, such as 45:55 to 55:45 (molar ratio of RAC1 to RAC2). In another embodiment, the concentration of RAC1 and RAC2 may vary over a wider range (molar ratios ranging from 10:90 to 90:10, or 25:75 to 75:25).

According to a further preferred embodiment, the concentration of RAC1 in the aqueous solution is at least 0.005 mol/l; preferably at least 0.01 mol/l. The concentration of RAC1 and RAC2 in the aqueous electrolyte solution is preferably less than 1 mol/l; more preferably less than 0.5 mol/l; even more preferably less than 0.1 mol/l. According to an embodiment, the concentration of RAC1 and RAC2 falls thus within a range of 0.005 mol/l and 1 mol/l or of 0.01 mol/l and 0.5 mol/l or of 0.01 mol/l and 0.1 mol/l.

The pH value of the aqueous electrolyte solution may be from 1 to 14; preferably, it is neutral or moderately basic, e.g. from 7 to 12, more preferably from 7 to 10 or from 8 to 10.

The energy density which is provided by the insoluble (organic or inorganic) energy storage material is at least 10 or at least 50 or at least 100 or at least 200 mWh/g. Thus, the energy density may range from 10 to 2000 mWh/g; preferably from 50 to 1000 mWh/g; especially preferably from 50 or 100 or 200 to 500 mWh/g.

RAC1 and/or RAC2 may be selected from a phenazine, a benzoquinone, a naphthaquinone or an anthraquinone, preferably a phenazine or anthraquinone, which are more preferably substituted by one or more substituent(s), preferably at least two or at least three substituents increasing their solubility in water, e.g. by a carboxy, hydroxyl, amino or sulfonic acid substituent. Compounds as described in the literature as redox-active species for redox flow batteries, e.g. by US 2014/0370403 A1 or WO 2014/052682 A2 (the compounds disclosed therein are incorporated herein by reference) may be employed as RAC1 and/or RAC2. Such compounds based on preferably substituted phenazines, anthraquinones, naphthaquinones or benzoquinones, preferably anthraquinones and phenazines, are preferred as anolytes, i.e. as redox active species of the anolytic electrolyte composition.

According to a preferred embodiment, redox-active compound RAC1 is a phenazine derivative, in particular a phenazine derivate with at least one, preferably at least two substituents rendering the derivative more water soluble. Thus, such a derivative may have at least one, preferably at least two sulfonyl groups as substituents, optionally in combination with at least one, preferably at least two hydroxy or C₁-C₆ alkoxy groups. Alternatively, such a derivative may have at least one, preferably at least two amino acid groups as substituents.

According to a further preferred embodiment, redox-active compound RAC2 contains a quinoid system, e.g. a substituted or unsubstituted benzoquinone, naphthaquinone and/or anthraquinone, in particular a substituted anthraquinone comprising at least one or at least two substituents rendering the compound more water-soluble.

According to a moreover preferred embodiment, a redox-active compound may be a compound having the following formula:

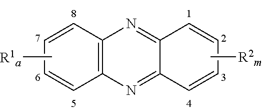

wherein
R¹ and R² are independently selected from C₁₋₅ alkyl, R^{x}OR³, R^{x}SO₃H, R^{x}COOH, R^{x}OM, R^{x}SO₃M, R^{x}COOM, R^{x}NR³₃X, R^{x}NR³₂, R^{x}PO(OH)₂, R^{x}SH, R^{x}PS(OH)₂, R^{x}OPO(OH)₂, R^{x}OPS(OH)₂, R^{x}SPS(OH)₂, and (OCH₂CH₂)ᵣOR³;
each R³ is independently H or C₁₋₅ alkyl;
each R^{x} is independently a bond or C₁₋₅ alkylene;
M is a cation;
X is an anion;
r is 1 or greater;
a is an integer of from 0 to 4;
m is an integer of from 0 to 4; and
the sum of a and m is an integer of from 1 to 8;
or a tautomeric form or a different oxidation state thereof.

According to a further preferred embodiment,
R¹ and R² are independently selected from R^{x}OR³, R^{x}SO₃H, R^{x}COOH, R^{x}OM, R^{x}SO₃M, R^{x}COOM, R^{x}NR³₃X, R^{x}NR³₂, and (OCH₂CH₂)ᵣOR³;
each R³ is independently H or C₁₋₅ alkyl;
each R^{x} is independently a bond or C₁₋₅ alkylene;
M is a cation;
X is an anion;
r is 1 or greater;
a is an integer of from 0 to 4;
m is an integer of from 0 to 4; and
the sum of a and m is an integer of from 1 to 4.

According to a further preferred embodiment,
R¹ and R² are independently selected from R^{x}OR³, R^{x}SO₃H, R^{x}OM, R^{x}SO₃M, R^{x}NH₃X, and R^{x}NH₂;
each R³ is independently H or C₁₋₅ alkyl;
each R^{x} is independently a bond or C₁₋₅ alkylene;
M is a cation;
X is an anion;
a is an integer of from 0 to 2;
m is an integer of from 0 to 2; and
the sum of a and m is an integer of from 1 to 3.

Preferably, R^{x} is a bond.

They may serve as RAC1 and/or RAC2 compounds depending on the redox potential of the individual phenazine derivative and the redox potential of the insoluble (organic) storage material. Preferably, the phenazine derivative is a RAC1 compound.

According to a preferred embodiment, a redox-active compound, which may act as RAC1 and/or RAC2, preferably RAC1, may be a compound having the following formula:

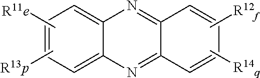

wherein
R¹¹ and R¹² are independently a group of formula —NH—R^{y}—COOH or —NH—R^{Y}—COOM;
R¹³ and R¹⁴ are independently selected from C₁₋₅ alkyl, R^{x}OR³, R^{x}SO₃H, R^{x}COOH, R^{x}OM, R^{x}SO₃M, R^{x}COOM, R^{x}NR³₃X, R^{x}NR³₂, R^{x}PO(OH)₂, R^{x}SH, R^{x}PS(OH)₂, R^{x}OPO(OH)₂, R^{x}OPS(OH)₂, R^{x}SPS(OH)₂, and (OCH₂CH₂)ᵣOR³;
each R³ is independently H or Cis alkyl;
each R^{x} is independently a bond or C₁₋₅ alkylene;
each R^{y} is independently C₁₋₅ alkylene;
M is a cation;
X is an anion;
r is 1 or greater;
e is an integer of from 1 to 4;
f is an integer of from 1 to 4;
p is an integer of from 0 to 3;
q is an integer of from 0 to 3;
the sum of e and p is an integer of from 1 to 4; and
the sum of f and q is an integer of from 1 to 4;
or a tautomeric form or a different oxidation state thereof.

According to a preferred embodiment, p and q are both 0.

According to a preferred embodiment, e and f are both 1.

According to another preferred embodiment, the above redox-active compound, which may act as RAC1 and/or RAC2, preferably RAC1, may be a compound having the following formula:

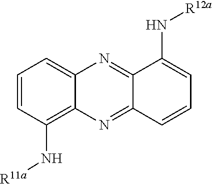

wherein
R^{11a} and R^{12a} are independently a group of formula —R^{y}—COOH or —R^{y}—COOM;
M is a cation; and
each R^{y} is independently C₁₋₅ alkylene;
or a tautomeric form or a different oxidation state thereof.

Moreover preferably, R^{y} is selected from the following groups: —CH₂—; —CH₂—CH₂—; —CH₂—CH₂—CH₂—; and —CH(CH₃)—.

The synthesis of the above phenazine derivatives is e.g. described in Shuai Pang et al. Angew. Chem. Int. Ed. 10.1002/anie.202014610.

The above described phenazine derivatives may serve as RAC1 and/or RAC2 compounds depending on the redox potential of the individual phenazine derivative and the redox potential of the insoluble (organic) storage material. Preferably, the phenazine derivative is a RAC1 compound.

According to another preferred embodiment, a redox-active compound, which may act as RAC1 and/or RAC2, preferably RAC2, is a compound having one of the following formulae:

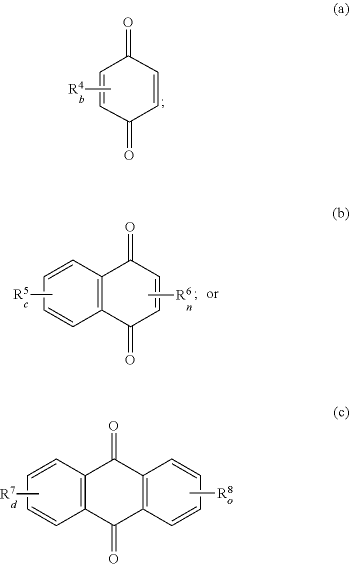

wherein
R⁴, R⁵, R⁶, R⁷ and R⁸ are independently selected from C₁₋₅ alkyl, R^{x}OR³, R^{x}SO₃H, R^{x}COOH, R^{x}OM, R^{x}SO₃M, R^{x}COOM, R^{x}NR³₃X, R^{x}NR³₂, R^{x}PO(OH)₂, R^{x}SH, R^{x}PS(OH)₂, R^{x}OPO(OH)₂, R^{x}OPS(OH)₂, R^{x}SPS(OH)₂, and (OCH₂CH₂)ᵣOR³;
each R³ is independently H or C₁₋₅ alkyl;
each R* is independently a bond or C₁₋₅ alkylene;
M is a cation;
X is an anion;
r is 1 or greater;
b is an integer of from 1 to 4;
c in an integer of from 0 to 4;
d is an integer of from 0 to 4;
n is an integer of from 0 to 2;
o is an integer of from 0 to 4;
the sum of c and n is an integer of from 1 to 6; and
the sum of d and o is an integer of from 1 to 8;
or a tautomeric form or a different oxidation state thereof.

According to a further preferred embodiment,
R⁴, R⁵, R⁶, R⁷ and R⁸ are independently selected from R^{x}OR³, R^{x}SO₃H, R*COOH, R^{x}OM, R^{x}SO₃M, R^{x}COOM, R^{x}NR³₃X, R^{x}NR³₂, and (OCH₂CH₂)ᵣOR³;
each R³ is independently H or C₁₋₅ alkyl;
each R* is independently a bond or C₁₋₅ alkylene;
M is a cation;
X is an anion;
r is 1 or greater;
b is an integer of from 1 to 4;
c in an integer of from 0 to 4;
d is an integer of from 0 to 4;
n is an integer of from 0 to 2;
is an integer of from 0 to 4;
the sum of c and n is an integer of from 1 to 4; and
the sum of d and o is an integer of from 1 to 4.

According to an especially preferred embodiment,
R⁴, R⁵, R⁶, R⁷ and R⁸ are independently selected from R^{x}OR³, R^{x}SO₃H, ROM, R^{x}SO₃M, R^{x}NR³₃X and R^{x}NR³₂;
each R³ is independently H or C₁₋₅ alkyl;
each R^{x} is independently a bond or C₁₋₅ alkylene;
M is a cation;
X is an anion;
b is an integer of from 1 to 3;
c in an integer of from 0 to 2;
d is an integer of from 0 to 3;
n is an integer of from 0 to 2;
o is an integer of from 0 to 3;
the sum of c and n is an integer of from 1 to 4; and
the sum of d and o is an integer of from 1 to 4.

Preferably, R^{x} is a bond.

According to another preferred embodiment, the above redox-active compound, which may act as RAC1 and/or RAC2, preferably RAC1, may be a compound as disclosed by WO 2020/035549 (whose disclosure, in particular its disclosure referring to General Formulae (1) to (6), is incorporated herein by reference) having the following formulae characterized by any one of General Formulae (1)-(6):

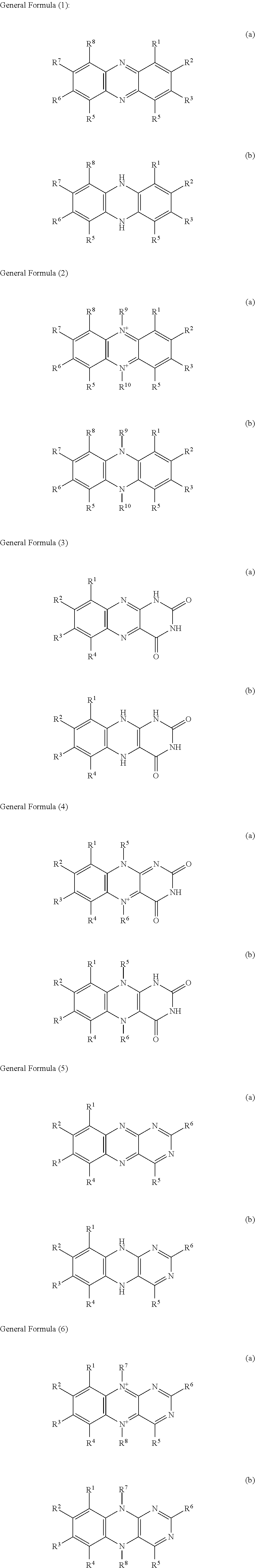

wherein,
each R¹-R⁸ in General Formula (1),
each R¹-R¹⁰ in General Formula (2),
each R¹-R⁴ in General Formula (3),
each R¹-R⁶ in General Formula (4),
each R¹-R⁶ in General Formula (5), and
each R¹-R⁸ in General Formula (6)
is independently selected from
—H, -Alkyl, -AlkylG^{a}, -Aryl, —SO₃H, —SO₃⁻; —PO₃H₂, —OH, —OG^{a}, —SH, -Amine, —NH₂,
—CHO, —COOH,
—COOG^{a}, —CN, —CONH₂, —CONHG^{a}, —CONG^{a}₂, -Heteroaryl, -Heterocycyl, NOG^{a},
N⁺OG^{a}, —F, —Cl, and —Br, or are joined together to form a saturated or unsaturated carbocycle, more preferably from —H, -Alkyl, -AlkyIG^{a}, —SO₃H/—SO₃⁻, OG^{a}, and —COOH;
wherein each G^{a} is independently selected from
—H, -Alkyl, -AlkylG^{b}, -Aryl, —SO₃H, —SO₃⁻, —PO₃H₂, —OH, —OAlkyl, —OOH, —OOAlkyl, —SH, —SAlkyl,
—NH₂, —NHAlkyl, —NAlkyl₂, —NAlkyl₃⁺, —NHG^{b}, —NG^{b}₂, —NG^{b}₃⁺, —CHO, —COOH,
—COOAlkyl, —CN,
—CONH₂, —CONHAlkyl, —CONAlkyl₂, -Heteroaryl, -Heterocycyl, —NOG^{b}, —N⁺OAlkyl, —F, —Cl, and —Br;
wherein each G^{b} is independently selected from
—H, -Alkyl, -Aryl, —SO₃H, —SO₃, —PO₃H₂, —OH, —OAlkyl, —OOH, —OOAlkyl, —SH, —SAlkyl,
—NH₂,
—NHAlkyl, —NAlkyl₂, —NAlkyl₃⁺, —CHO, —COOH, —COOAlkyl, —CN, —CONH₂,
—CONHAlkyl, —CONAlkyl₂, -Heteroaryl, -Heterocycyl, —N⁺OAlkyl, —F, —Cl, and Br.

According a more preferred embodiment, the substituents of the above General Formulae (1) to (6) chosen
R¹-R⁸ in General Formula (1),
R¹-R¹⁰ in General Formula (2),
R¹-R⁴ in General Formula (3),
R¹-R⁶ in General Formula (4),
R¹-R⁶ in General Formula (5), and
R¹-R⁸ in General Formula (6)
are independently selected from -Alkyl, -AlkylG^{a}, -Aryl, —SO₃H, —SO₃, —PO₃H₂, —OH,
—OG^{a}, —SH, -Amine, —NH₂, —CHO, —COOH, —COOG^{a}, —CN, —CONH₂, —CONHG^{a},
—CONG^{a}₂, -Heteroaryl, -Heterocycyl, NOG^{a}, —N⁺OG^{a}, —F, —Cl, and —Br, or are joined together to form a saturated or unsaturated carbocycle, more preferably from -Alkyl, -AlkylG^{a}, —SO₃H/—SO₃⁻, —OG^{a}, and —COOH;
wherein each G^{a} is independently selected from
—H, -Alkyl, -AlkylG^{b}, -Aryl, —SO₃H, —SO₃, —PO₃H₂, —OH, —OAlkyl, —OOH, —OOAlkyl, —SH, —SAlkyl, —NH₂, —NHAlkyl, —NAlkyl₂, —NAlkyl₃⁺, —NHG^{b}, —NG^{b}₂, —NG^{b}₃⁺, —CHO, —COOH,
—COOAlkyl, —CN, —CONH₂, —CONHAlkyl, —CONAlkyl₂, -Heteroaryl, Heterocycyl,
—NOG^{b}, —N⁺OAlkyl, —F, —Cl, and —Br;
wherein each G^{b} is independently selected from
—H, -Alkyl, -Aryl, —SO₃H, —SO₃⁻, —PO₃H₂, —OH, —OAlkyl, —OOH, —OOAlkyl, —SH, —SAlkyl,
—NH₂, —NHAlkyl, —NAlkyl₂, —NAlkyl₃⁺, —CHO, —COOH, —COOAlkyl, —CN, —CONH₂,
—CONHAlkyl, —CONAlkyl₂, -Heteroaryl, -Heterocycyl, —N⁺OAlkyl, —F, —Cl, and —Br.

The term “alkyl” according to above General Formulae (1) to (6) may be selected from linear, branched or cyclic —CₙH₂ₙ₋ₒ and —CₙH₂ₙ₋ₒ₋ₘG^{a}ₘ; in particular a C1 to C6 hydrocarbon chain (including ethyl, methyl or propyl).

The term “aryl” “according to above General Formulae (1) to (6) may be selected from —C₆H₅, —C₁₀H₇, C₁₃H₈, C₁₄H₉, —C₆H₅₋ₘG^{a}ₘ, —C₁₀H₇₋ₘG^{a}ₘ, C₁₃H₈₋ₘG^{a}ₘ, C₁₄H₉₋ₘG^{a}ₘ; in particular phenyl;

The term “heteroaryl” “according to above General Formulae (1) to (6) may be selected from —C₅₋ₚNₚH_{5-p-q}G^{a}_{q}, —C₆₋ₚNₚH_{5-p-q}G^{a}_{q}, —C₇₋ₚNₚH_{7-p-q}G^{a}_{q}, —C₈₋ₚNₚH_{6-p-q}G^{a}_{q}, —C_{9- p}NₚH_{7-p-q}G^{a}_{q}, —C₁₀₋ₚNₚH_{7-p-q}G^{a}_{q}, —C₄OH_{3-q}G^{a}_{q}, —C₆OH_{5-q}G^{a}_{q}, —C₇OH_{4-q}G^{a}_{q}, —C₆O₂H_{3-q}G^{a}_{q}, —C₈OH_{5-q}G^{a}_{q}, —C₄SH_{3-q}G^{a}_{q}, —C₆SH_{5-q}G^{a}_{q}, —C₇SH_{4-q}G^{a}_{q}, —C₆S₂H_{3-q}G^{a}_{q}, —C₈SH_{5-q}G^{a}_{q}, —C₃ONₚH_{3-p-q}G^{a}_{q}, —C₆ONₚH_{5-p-q}G^{a}_{q}, —C₇ONₚH_{4-p-q}G^{a}_{q}, —C₆O₂NₚH_{3-p-q}G^{a}_{q}, —C₈ONₚH_{5-p-q}G^{a}_{q}, —C₃SNₚH_{3-p-q}G^{a}_{q}, —C₆SNₚH_{5-p-q}G^{a}_{q}, —C₇SNₚH_{4-p-q}G^{a}_{q}, —C₆S₂NₚH_{3-p-q}G^{a}_{q}, —C₆OSNₚH_{3-p-q}G^{a}_{q}, —C₈SNₚH_{5-p-q}G^{a}_{q}, —C₅₋ₚNₚ⁺H_{6-p-q}G^{a}_{q}, —C₆₋ₚNₚ⁺H_{6-p-q}G^{a}_{q}, —C₇₋ₚNₚ⁺H_{8-p-q}G^{a}_{d}, —C₈₋ₚNₚ⁺H_{7-p-q}G^{a}_{q}, —C₉₋ₚNₚ⁺H_{8-p-q}G^{a}_{q}, —C₁₀₋ₚNₚ⁺H_{8-p-q}G^{a}_{q}, —C₃ONₚ⁺H_{4p-q}G^{a}_{q}, —C₆ONₚ⁺H_{6-p-q}G^{a}_{q}, —C₇ONₚ⁺H_{5-p-q}G^{a}_{q}, —C₆O₂Nₚ⁺H_{4-p-q}G^{a}_{q}, —C₈ONₚ⁺H_{6-p-q}G^{a}_{q}, —C₃SNₚ⁺H_{4-p-q}G^{a}_{q}, —C₆SNₚ⁺H_{6-p-q}G^{a}_{q}, —C₇SNₚ⁺H_{5-p-q}G^{a}_{q}, —C₆S₂Nₚ⁺H_{4-p-q}G^{a}_{q}, —C₆OSNₚ⁺H_{4-p-q}G^{a}_{q}, —C₈SNₚ⁺H_{6-p-q}G^{a}_{q};

The term “heterocyclyl” “according to above General Formulae (1) to (6) may be selected from —C₅₋ₚNₚH_{8-o-p-q}G^{a}_{q}, —C₆₋ₚNₚH_{10-p-q}G^{a}_{q}, —C₇₋ₚNₚH_{12-o-p-q}G^{a}_{q}, —C₈₋ₚNₚH_{14-o-p-q}G^{a}_{q}, —C₉₋ₚNₚH_{16-o-p-q}G^{a}_{q}, —C₁₀₋ₚNₚH_{18-o-p-q}G^{a}_{q}, —C₅₋ₚOₚH_{8-o-2p-q}G^{a}_{q}, —C₆₋ₚOₚH_{10-o-2p-q}G^{a}_{q}, —C₇₋ₚOₚH_{12-o-2p-q}G^{a}_{q}, —C₈₋ₚOₚH_{14-o-2p-q}G^{a}_{q}, —C₉₋ₚOₚH_{16-o-2p-q}G^{a}_{q}, —C₁₀₋ₚOₚH_{18-o-2p-q}G^{a}_{q}, —C₅₋ₚSₚH_{8-o-2p-q}G^{a}_{q}, —C₆₋ₚSₚH_{10-o-2p-q}G^{a}_{q}, —C₇₋ₚSₚH_{12-o-2p-q}G^{a}_{q}, —C₈₋ₚSₚH_{14-o-2p-q}G^{a}_{q}, —C₉₋ₚSₚH_{16-o-2p-q}G^{a}_{q}, —C₁₀₋ₚSₚH_{18-o-2p-q}G^{a}_{q}, —C₅₋ₚOₗNₚH_{8-o-p-2l-q}G^{a}_{q}, —C₆₋ₚOₗNₚH_{10-o-p-2l-q}G^{a}_{q}, —C₇₋ₚOₗNₚH_{12-o-p-2l-q}G^{a}_{q}, —C₈₋ₚOₗNₚH_{14-o-2l-q}G^{a}_{q}, —C₉₋ₚOₗNₚH_{16-o-2l-q}G^{a}_{q}, —C₁₀₋ₚOₗNₚH_{18-o-p-2l-q}G^{a}_{q}, —C₅₋ₚSₗNₚH_{8-o-2l-q}G^{a}_{q}, —C₆₋ₚSₗNₚH_{10-o-p-2l-q}G^{a}_{q}, —C₇₋ₚSₗNₚH_{12-o-p-2l-q}G^{a}_{q}, —C₈₋ₚSₗNₚH_{14-o-p-2l-q}G^{a}_{d}, —C₉₋ₚSₗNₚH_{16-o-p-2l-q}G^{a}_{q}, —C₁₀₋ₚSₗNₚH_{18-o-p-2l-q}G^{a}_{q}; in particular to a 3- to 14-membered non-aromatic ring system having ring carbon atoms and 1 to 4 ring heteroatoms, wherein each heteroatom is independently selected from nitrogen, oxygen, and sulfur (“3-14 membered heterocyclyl”).

The term “amine” “according to above General Formulae (1) to (6) may be selected from —CₛH₂ₛ—NH₂, —CₛH₂ₛ—NHG^{a}, —CₙH₂ₛ—NG^{a}₂, —CₛH₂ₛ—NG^{a}₃⁺,
wherein for the above terms, the following definitions hold
l=1, 2, 3, 4,
n=1, 2, 3, 4, 5, 6, 7, 8, 9, 10, more preferably n=1, 2, 3, 4, 5, 6, most preferably n=1, 2, 3 or 4,
m=1, 2, 3, 4, 5, 6, 7, 8, 9, 10, more preferably m=1, 2, 3, 4, most preferably m=1 or 2,
o=−1, 2, 3, 5, 7, 9,
p=1, 2, 3, 4, 5, 6, more preferably p=3, 4, 5 or 6,
q=1, 2, 3, 4, 5, more preferably q=1, 2 or 3,
s=1, 2, 3, 4, 5 or 6;

In some embodiments of the above General Formulae (1) to (6), each R¹-R⁸ in General Formula (1), each R¹-R¹⁰ in General Formula (2), each R¹-R⁴ in General Formula (3), each R¹-R⁶ in General Formula (4), each R¹-R⁶ in General Formula (5), and each R¹-R⁸ in General Formula (6) is independently not selected from —SH, —NOG^{a} and —N⁺OG^{a}, wherein G^{a} is as defined above.

In some embodiments of the above General Formulae (1) to (6), each G^{a} in any one of General Formulas (1)-(6) is independently not selected from —OOH, —OOAlkyl, —SH, —NOG^{b} and —N⁺OAlkyl, wherein G^{b} is as defined above.

In some embodiments of the above General Formulae (1) to (6), each G^{b} in any one of General Formulas (1)-(6) is independently not selected from —OOH, —OOAlkyl, —SH, and —N⁺OAlkyl.

In some embodiments of the above General Formulae (1) to (6), the compounds may preferably comprise at least one —SO₃H/—SO₃ group.

In some embodiments of the above General Formulae (1) to (6), the compounds may preferably comprise at least one hydroxyl group. If more than one hydroxyl group is represented, they are preferably located at adjacent positions of the ring system.

In some embodiments of the above General Formulae (1) to (6), the compounds may preferably comprise at least one alkyl group.

In some embodiments of the above General Formulae (1) to (6), the compounds may preferably comprise at least one alkyoxy (alkoxy) group.

In some embodiments of the above General Formulae (1) to (6), the compounds may preferably comprise at least one carboxyl group.

In some embodiments of the above General Formulae (1) to (6), the compounds may preferably comprise at least one amine group.

More specifically, compounds acting as RAC1 and/or RAC2, preferably RAC1, according to the above General Formulae (1) to (6) comprise a —SO₃H/—SO₃⁻ group and at least one other substituent selected from the group consisting of an alkoxy group, e.g. methoxy group, a hydroxyl group and a carboxyl group. In another embodiment, the compounds of the above General Formulae (1) to (6) comprise by their substitution pattern at least one hydroxyl group, preferably two hydroxyl groups, and at least one other substituent selected from the group consisting of an carboxyl group, a —SO₃H/—SO₃⁻ group, and an alkoxy group. In a further preferred embodiment of the above General Formulae (1) to (6), the compound comprises as substituents at least one alkoxy, e.g. methoxy group, and at least one hydroxyl group. In a further alternative embodiment of the above General Formulae (1) to (6), the compound comprises as substituents at least one carboxyl group and at least one —SO₃H/—SO₃⁻ group. In a still further embodiment of the above General Formulae (1) to (6), the compound comprises as substituents at least one —SO₃H/—SO₃ group and at least one hydroxyl group. In a still further embodiment of the above General Formulae (1) to (6), the compound comprises as substituents at least one —SO₃H/—SO₃ group and at least one alkoxy, e.g. methoxy, group. In a further alternative embodiment of the above General Formulae (1) to (6), the compound comprises as substituents at least one carboxyl and at least one hydroxyl group. In a still further embodiment of the above General Formulae (1) to (6), the compound comprises as substituents at least one —SO₃H/—SO₃⁻ group, at least one hydroxyl and at least one methoxy group. In another preferred embodiment of the above General Formulae (1) to (6), the compound comprises as substituents at least one —SO₃H/—SO₃⁻ group, at least one hydroxyl and at least one carboxyl group. In a still further preferred embodiment of the above General Formulae (1) to (6), the compound comprises as substituents at least one alkoxy, e.g. methoxy, group, at least one hydroxyl and at least one carboxyl group. In a preferred embodiment of the above General Formulae (1) to (6), the compound comprises a methoxy, a hydroxyl and a —SO₃H/—SO₃⁻ group.

In combination with at least one —SO₃H/—SO₃⁻ group, it is also advantageous for the compound of the above General Formulae (1) to (6) to comprise as substituents at least one alkyl group, e.g. a methyl group, specifically two alkyl groups. Any of the above embodiments comprising an —SO₃H/—SO₃⁻ group (and at least one of a carboxyl group, hydroxyl group and/or alkoxy group) may thus also comprise at least one alkyl group, e.g. one or two alkyl groups, specifically one alkyl group.

The above substitution patterns refer to all of General Formulas (1) to (6), in particular to General Formulas (1) and (2).

Preferred compounds to serve as RAC1 and/or RAC2, preferably RAC1, are e.g. selected from the following compounds (or their reduced counterparts):

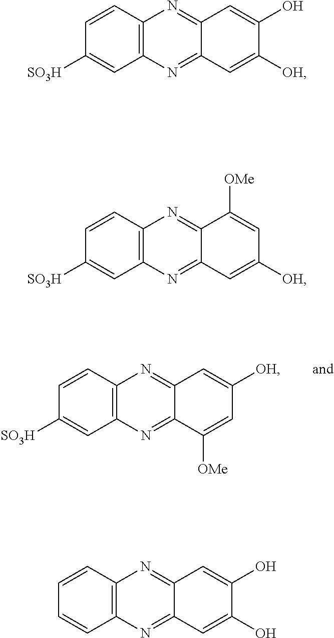 [SMILES: O=S(=O)(O)c1ccc2nc3cc(O)c(O)cc3nc2c1 ; COc1cc(O)cc2nc3cc(S(=O)(=O)O)ccc3nc12 ; COc1cc(O)cc2nc3ccc(S(=O)(=O)O)cc3nc12 ; Oc1cc2nc3ccccc3nc2cc1O]

or any combination of two or more of the above.

Other specifically preferred compounds (or their reduced counterparts) acting as RAC1 and/or RAC2, preferably RAC1, are selected from

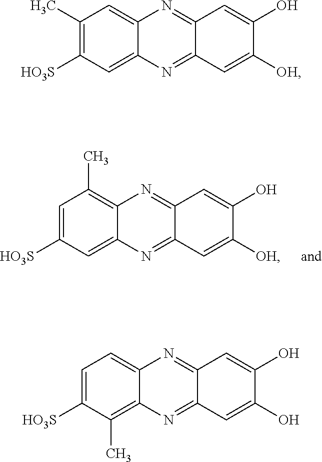 [SMILES: Cc1cc2nc3cc(O)c(O)cc3nc2cc1S(=O)(=O)O ; Cc1cc(S(=O)(=O)O)cc2nc3cc(O)c(O)cc3nc12 ; "and" ; Cc1c(S(=O)(=O)O)ccc2nc3cc(O)c(O)cc3nc12]

or any combination thereof, in particular a combination of all of the above three compounds each having a methyl group at another position of the phenazine ring system.

Other preferred compounds (or their reduced counterparts) acting as RAC1 and/or RAC2, preferably RAC1, are selected from

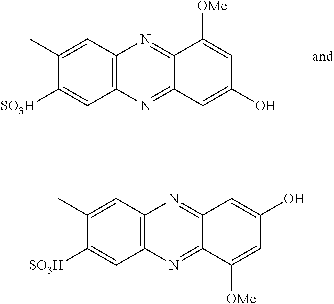 [SMILES: COc1cc(O)cc2nc3cc(S(=O)(=O)O)c(C)cc3nc12 ; COc1cc(O)cc2nc3cc(C)c(S(=O)(=O)O)cc3nc12]

or a combination thereof.

Quinoid systems having a redox potential of < than the depot material may serve as RAC1. Preferably, they may have a redox potential of > than the depot material and may thus serve as a RAC2 compound. Vice versa, phenazine compounds having a redox potential > than the redox potential of the depot material may serve as RAC2 compounds. The redox potential of an organic compound serving as RAC1 may be less than −0.7 V or less than −0.8 V and may range preferably from −0.8 V to −1.2 V or −1.3 V. The choice of the RAC1 compound depends on the redox potential of the depot material. A redox potential of the depot material of e.g. −0.7 V may require a RAC1 compound with a redox potential of <−0.725 V. Preferably, the insoluble organic depot material may have a redox potential of from −0.6 V to −1.2 V or from −0.65 V to −1.8 V or from −0.65 V to −0.8 V. The RAC2 compound has a redox potential, which is shifted towards less negative redox potentials as compared to RAC1 and the insoluble organic depot material. Thus, depending on the redox potential of the derivative, RAC2 may have a redox potential of >−1.2 V or >−1.0 V or >−0.8 V or >−0.7 V. It may be in the range of −1.2 V and −0.4 V, e.g. >−0.675 V, if the depot material has a redox potential of −0.7 V.

The inventive composition as disclosed above is typically used as an anolyte. Its redox-active species have typically a negative redox potential (at pH 14 vs. SHE). The redox potential of an organic compound serving as RAC1 may be less than −0.7 V or less than −0.8 V and may range from −0.7 V to −1.2 V or −1.3 V. The choice of the RAC1 compound depends on the redox potential of the depot material.

An embodiment of the present invention is based on an electrolyte composition based on an aqueous solvent having a water content of at least 50% (by weight) containing the RCA1, RAC1 and the insoluble energy storage material. The RAC 1, RAC 2 species and the energy storage material for storing electrical energy contained by the composition are reversibly redox-active. They do not form irreversible complexes with each other or with water. Preferably, the RAC1 species is a substituted phenazine and the RAC2 species is a substituted quinoid system, preferably a substituted benzoquinone, naphthaquinone or anthraquinone. Preferably, the energy storage material is of organic nature having an energy storage density of at least 10 mWh/g. Such an embodiment is typically used as an anolyte composition.

Another embodiment of the present invention is based on an electrolyte composition based on an aqueous solvent having a water content of at least 50% (by weight) containing the RAC1, RAC2 species and the energy storage material. The RAC 1, RAC 2 species and the energy storage material for storing electrical energy contained by the composition are reversibly redox-active. They do not form irreversible complexes with each other or with water. Preferably, the RAC1 species is an iron complex and the RAC2 species is another iron complex, preferably one of the iron complexes (as RAC1 or RAC2) is iron hexacyanoferrate and the other iron complex is an optionally substituted bipyridyl Fe complex or an optionally substituted ferrocene. Preferably, the energy storage material is of organic or inorganic nature having an energy storage density of at least 10 mWh/g. Such an embodiment is typically used as a catholyte composition.

Also disclosed are further electrolyte compositions based on inorganic redox active species. Thereby the RAC1 and/or RAC2 compound may be selected from a substituted or unsubstituted bipyridyl iron complex or an unsubstituted or preferably substituted ferrocene in combination with another metal complex, e.g. an iron complex, e.g. iron hexacyanoferrate as the other of RAC1 or RAC2. Such compositions in combination with an energy storage material, of organic or, preferably, of inorganic nature, are disclosed herein as well. More specific embodiments of the RAC1/RAC2 species and of the organic or inorganic energy storage material are disclosed further below. Such compositions containing inorganic redox species as RAC1 and/or RAC2 are preferably used as the catholyte for a redox-flow battery. Again, the redox potential of the energy storage material is in between the redox potential of RAC 1 and RAC2. Typically, RAC1 and RAC2 have a redox potential which is at least 0.3 V, at least 0.4 V, at least 0.5 V or at least 0.7 V higher/lower than the redox potential of the energy storage material.

The energy storage material typically serves to store electrical energy. Such storage of electrical energy is established by stable redox active species (RA!/RAC1, which are reversible redox active and may thus be charged/discharged. Typically, they may be charged/discharged by more than 100 or more than 1000 cycles. Analogously, the energy storage material is a reversible redox-active compound. It is typically stable over a larger number of charging/discharging cycles. According to a further embodiment, the at least one insoluble organic or inorganic energy storage material is selected from an organic, in particular of a polymeric organic compound, or an inorganic compound, e.g. a metal salt. Typically, the organic or inorganic compounds are insoluble such that they are positioned as solid material in the tank containing the electrolyte. Preferably, the energy storage material of the catholytic electrolyte may be selected from an organic (e.g. PANI) or an inorganic compound. The energy storage material of the anolytic electrolyte is typically of organic nature and may preferably be a polymer. More preferably, the energy storage material of the catholytic electrolyte may be selected from an inorganic compound and the energy storage material of the anolytic electrolyte may be selected from an organic compound, in particular from an organic polymeric compound.

The organic compound as energy storage material may be polymer, which is completely conjugated or a polymer which not completely conjugated. The polymer may be a linear polymer or a branched polymer, preferably a linear polymer.

Organic compound as energy storage material may be selected from the group consisting of tetraazapentacene (TAP), poly-ortho-phenylenediamine, poly-para-phenylenediamine, poly-meta-phenylenediamine, 2,3-diaminophenazine (DAP), trimethylquinoxaline, (TMeQ), dimethylquinoxaline (DMeQ), polyaniline (PANI) Prussian Blue (PB), poly (neutral red); N,N′-diphenyl-1,4,5,8-naphthalenetetracarboxylic diimide; and poly (N-ethyl-naphthalenetetracarboxylic diimide); or a tautomeric form or a different oxidation state thereof.

The following compounds may thus be employed as organic energy storage material:

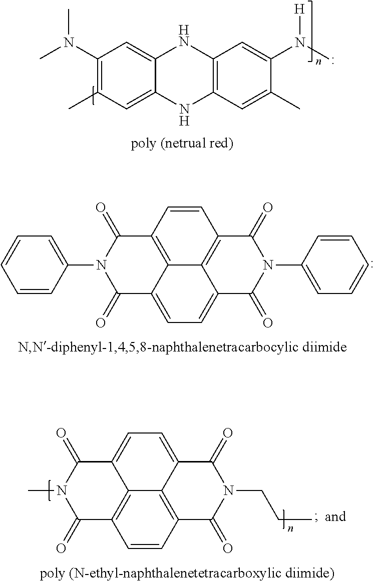

or a tautomeric form or a different oxidation state thereof.

The organic compound as energy storage material may be a polymer composed of heterogeneous monomers. Thus, in one embodiment, the polymeric compound may be composed of monomers selected from two or three of poly-ortho-phenylenediamine, poly-para-phenylenediamine, and poly-meta-phenylenediamine, preferably the heterogeneous polymer is composed of all (3) of them. Such an organic energy storage material is typically employed as the energy storage material of the anolyte.

The inorganic compounds, typically employed as energy storage material of the catholyte, may be selected from an insoluble inorganic energy storage material from the group consisting of a metal salt, preferably a metal oxide (e.g. a metal oxide containing mineral) or a metal hydroxide. More preferably, the metal is selected from Fe, Ni, Mn, Co, and Cu, or, more preferably from Ni and Mn. Thereby, the inorganic compound may be MnO or Ni(OH)₂, preferably MnO. MnO may be used as such or as an MnO containing mineral. A preferred MnO containing mineral is Birnessit which corresponds to a hydrous manganese dioxide mineral. MnO, e.g. by its mineral Birnessit, may thus be employed as the energy storage material of the catholytic electrolyte composition.

The energy storage material for the catholytic and the analytic electrolyte is preferably not based on a Li salt or a Li containing compound. Preferably, the electrolyte composition as disclosed herein does not contain any Li.

The present invention further provides the use of the composition of the present invention as an electrolyte, in particular an anolyte, in a redox flow battery.

The present invention moreover provides a half-cell comprising the composition of the present invention and an electrode, in particular an anode.

The present invention further provides the use of the half-cell of the present invention as a compartment (especially an anodic compartment) of a redox-flow battery.

The present invention moreover provides a redox-flow battery comprising the composition of the present invention or a half-cell of the invention.

Although the present invention is described in detail herein, it is to be understood that this invention is not limited to the particular methodologies, protocols and reagents described herein as these may vary. It is also to be understood that the terminology used herein is not intended to limit the scope of the present invention which will be limited only by the appended claims. Unless defined otherwise, all technical and scientific terms used herein have the same meanings as commonly understood by one of ordinary skill in the art.

The features of the present invention are described herein. These features are further described for specific embodiments. It should, however, be understood that they may be combined in any manner and in any number to generate additional embodiments. The variously described examples and preferred embodiments, should not be construed to limit the present invention to only explicitly described embodiments. This present description should be understood to support and encompass embodiments, which combine the explicitly described embodiments, with any number of the disclosed and/or preferred features. Furthermore, any permutations and combinations of all described features in this application shall be considered supported by the description of the present application, unless it is understood otherwise.

Throughout this specification and the claims which follow, unless the context requires otherwise, the term “comprise”, and variations such as “comprises” and “comprising”, will be understood to imply the inclusion of a stated member, integer or step but not the exclusion of any other non-stated member, integer or step. The term “consist of” is a particular embodiment of the term “comprise”, wherein any other non-stated member, integer or step is excluded. In the context of the present invention, the term “comprise” encompasses the term “consist of”. The term “comprising” thus encompasses “including” as well as “consisting” e.g., a composition “comprising” X may consist exclusively of X or may include something additional e.g., X+Y.

The terms “a” and “an” and “the” and similar reference used in the context of describing the invention (especially in the context of the claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. No language in the specification should be construed as indicating any non-claimed element essential to the practice of the invention.

The word “substantially” does not exclude “completely” e.g., a composition which is “substantially free” from Y may be completely free from Y. Where necessary, the word “substantially” may be omitted from the definition of the invention.

The term “about” in relation to a numerical value x means x±10%.

The redox potential (also known as oxidation/reduction potential, ‘ORP’, pe, E₀′, or Eₕ) is a measure of the tendency of a chemical species to acquire electrons from or release electrons to an electrode, thereby being reduced or oxidized, respectively. Redox potential is measured in volts (V), or millivolts (mV). The redox potential may e.g. be determined according to DIN 38404-6:1984-05. The standard hydrogen electrode (SHE) may e.g. be used as reference electrode. The aqueous electrolyte solution has typically a basic pH of 14 when defining the redox potential of the applied redox-active species dissolved in the solution and the insoluble organic material as depot.

Unless denoted otherwise, the term “alkyl” refers to the radical of saturated hydrocarbon groups, including linear (i.e. straight-chain) alkyl groups, branched-chain alkyl groups, cyclo-alkyl (alicyclic) groups, alkyl-substituted cyclo-alkyl groups, and cyclo-alkyl-substituted alkyl groups. The term “alkylene” refers to a divalent alkyl group.

For example, an alkyl group contains from 1 to 5 carbon atoms (“C₁₋₅ alkyl”). In some embodiments, an alkyl group may contain 1 to 4 carbon atoms (“C₁₋₄ alkyl”), from 1 to 3 carbon atoms (“C₁₋₃ alkyl”), or from 1 to 2 carbon atoms (“C₁₋₂ alkyl”).

Examples of C₁₋₅ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), and pentyl (C₅) (e.g., n-pentyl, 3-pentanyl, amyl, neopentyl, 3-methyl-2-butanyl, tertiary amyl).

Examples for cations are sodium, potassium or ammonium or mixtures thereof.

Examples for anions are Cl⁻, Br⁻, I⁻, and ½ SO₄²⁻.

It is understood that compounds shown herein may have tautomeric forms from which only one might be specifically mentioned or depicted in the present description. All these tautomeric forms are included in the invention.

It is understood that the compounds representing RAC1, RAC2 and the insoluble (organic) energy storage material as disclosed above have different oxidation states (oxidation numbers) from which only one is specifically depicted in the present description. The present invention is intended to encompass all oxidation states of these compounds.

Preferably, the term “redox-active” refers to the capability of a compound (or a composition comprising the same) to participate in a redox reaction. Such “redox-active” compounds typically have energetically accessible levels that allow redox reactions to alter their charge state, whereby electrons are either removed (oxidation) yielding an oxidized form of the compound from atoms of the compound being oxidized or transferred to the compound being reduced (reduction) yielding a reduced from of the compound. A “redox-active” compound may thus be understood as a chemical compound, which may form a pair of an oxidized and a reduced form, i.e. a redox pair, depending on the applied redox potential.

The term “redox-active compound” preferably relates to a compound or component that is capable of forming redox pairs having different oxidation and reduction states. In a redox flow battery an electrochemically active component refers to the chemical species that participate in redox reduction during the charge and discharge process.

The term “aqueous solution” refers to a solvent system comprising at least about 50% (by weight) of water, relative to the total weight of the solvent. In some applications, soluble, miscible, or partially miscible (emulsified with surfactants or otherwise) co-solvents may also be applied which, for example, extend the range of water's liquidity (e.g., alcohols/glycols). Thus, up to 50% or up to 40% or up to 30% (by weight) of organic co-solvents being miscible with water may be added, preferably from 10 to 40% (by weight) or from 10 to 30% (by weight). Preferred organic co-solvents may be selected from methanol, ethanol, DMSO, acetaldehyde, acetonitrile and mixtures of any of the afore-mentioned organic co-solvents, more preferably selected from methanol, DMSO and acetonitrile or any mixtures thereof. The addition of organic water-miscible co-solvents may increase the solubility of the RAC1/RAC2 species. In addition to the redox active electrolytes described herein, the electrolyte solutions may contain additives such as acids, bases, stabilizers, ionic liquids, buffering agents, supporting electrolytes, viscosity modifiers, wetting agents, and the like. Examples for such additives are NaOH and KOH. They are not considered as redox-active species.

The term “aqueous solution” may preferably refer to solvent systems comprising at least about 55%, at least about 60 wt %, at least about 70 wt %, at least about 75 wt %, at least about 80%, at least about 85 wt %, at least about 90 wt %, at least about 95 wt %, or at least about 98 wt % water, relative to the total solvent. The aqueous solvent may also consist essentially of water, and be substantially free or entirely free of any co-solvent. The solvent system may be at least about 90 wt %, at least about 95 wt %, or at least about 98 wt % water, or may be free of any co-solvent or other (non-target compound) species. Co-solvents may be water-miscible organic solvents, e.g. ethanol, DMSO, chloroform etc. The aqueous solution may thus comprise water and at least one further water-miscible co-solvent, e.g. one or two water miscible co-solvent(s).

The present invention also provides a redox flow battery comprising the composition according to the present invention. Such a redox flow battery comprises a first half cell comprising the composition according to the present invention; and a second half-cell comprising an electrolyte solution comprising at least one redox active species.

The compositions of the present invention may be used as catholytes and/or anolytes, preferably as anolytes. The term “catholytes” refers to the part or portion of an electrolyte, which is on the cathode side of a redox-flow battery half-cell, whereas the term “anolyte” refers to the part or portion of an electrolyte, which is on the anode side of a redox-flow battery half-cell. It is conceivable to employ the inventive compositions both as catholytes and anolytes in each half-cell (i.e. anode side and cathode side) of the same redox flow battery, thereby e.g. providing an “all-organic” redox flow battery. It is however also conceivable to provide the compositions of the invention as either catholytes or anolytes e.g. in an “half-organic” redox flow battery. Therein, the compositions are e.g. utilized as anolytes, whereas the catholyte comprises an inorganic redox active species. Examples for such inorganic redox active species include transition metal ions and halogen ions, such as VCl₃/VCl₂, Br/ClBr₂, Cl₂/Cl⁻, Fe²⁺/Fe³⁺, Cr³⁺/Cr²⁺, Ti³⁺/Ti²⁺, V³⁺/V²⁺, Zn/Zn²⁺, Br₂/Br⁻, I³⁻/I⁻, VBr₃/VBr₂, Ce³⁺/Ce⁴⁺, Mn²⁺/Mn³⁺, Ti³⁺/Ti⁴⁺, Cu/Cu⁺, Cu⁺/Cu²⁺, and others.

Generally, a catholyte is charged when a redox couple is oxidized to a higher one of two oxidation states, and is discharged when reduced to a lower one of the two oxidation state:

### Cathode: (C: Catholyte)

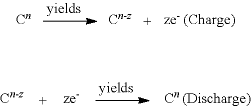

In contrast, an anolyte is charged when a redox couple is reduced to a lower one of two oxidation states, and is discharged when oxidized to a higher one of the two oxidation states:

### Anode: (A: Anolyte)

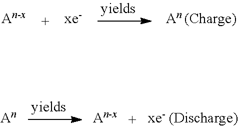

The standard (redox flow battery) cell potential (E^{∘}_{cell}) is the difference in the standard electrode potentials (against the standard hydrogen electrode (SHE)) of the two half-cell reactions of the catholyte and anolyte.

$${E}_{cell}^{0} = {E}_{cat}^{0} - {E}_{an}^{0} \qquad eq \text{.1}$$

(E^{∘}_{cell}=(redox flow battery) cell potential under standard conditions, E^{∘}_{cat}: standard reduction potential for the reduction half reaction occurring at the cathode, E^{∘}ₐₙ: standard reduction potential for the oxidation half reaction occurring at the anode).

The Nernst Equation (eq. 2) enables the determination of cell potential under non-standard conditions. It relates the measured cell potential to the reaction quotient and allows the accurate determination of equilibrium constants (including solubility constants).

$${E}_{cell} = {E}_{cell}^{0} - \frac{RT}{nF} ln Q \qquad eq . 2$$

(E_{cell}=(redox flow battery) cell potential under non-standard conditions, n=number of electrons transferred in the reaction, F=Faraday constant (96,500 C/mol), T=Temperature and Q=reaction quotient of the redox reaction).

As mentioned above, in one aspect, the present invention provides a redox flow battery comprising at least one composition according to the present invention.

As further mentioned above, the present invention further provides a redox flow battery comprising
a first half cell comprising the composition according to the present invention; and
a second half-cell comprising an electrolyte solution comprising a redox active species.

According to a preferred embodiment, the present invention provides a redox flow battery as described above, wherein said redox flow battery comprises
a first electrolyte comprising a first redox active compound;
a first electrode in contact with said first electrolyte;
a second electrolyte comprising a second redox active compound;
a second electrode in contact with said second electrolyte;
   wherein at least one of the first and second electrolyte is selected from a composition according to the present invention; and
a separator, preferably a polymer membrane interposed between the first and the second electrode.

According to a further preferred embodiment, the present invention provides a redox flow battery as described above, wherein said Redox Flow Battery comprises at least one flow-by electrode.

According to a moreover preferred embodiment, the present invention provides a redox flow battery as described above, wherein said redox flow battery comprises at least one carbon-based electrode.

According to a further preferred embodiment, the present invention provides a redox flow battery as described above, wherein said redox flow battery comprises a carbon-based electrode other than carbon felt, carbon cloth and carbon paper.

According to a moreover preferred embodiment, the present invention provides a redox flow battery as described above, wherein
the first electrolyte comprises, preferably as the anolyte (or “negolyte”), a composition according to the present invention; and
the second electrolyte comprises, preferably as the catholyte (or “posolyte”), a composition comprising at least one inorganic redox active species, preferably a metal ion salt, more preferably an Fe ion salt.

According to a further preferred embodiment, the present invention provides a redox flow battery as described above, wherein the second electrolyte is a solution comprising a salt of Fe(CN)₆³⁻, Fe(CN)₆⁴⁻ and/or combinations thereof, preferably an alkali salt, more preferably a Na⁺ and/or K⁺ salt.

By another preferred embodiment, the catholyte may be selected from ferrocene (bis(η⁵-cyclopentadienyl)iron) or a ferrocene derivative. The ferrocene derivative advantageously exhibits one or two substituents at one or both of the cyclopentadienyl ring systems. Preferred substituent are selected from hydroxyl, sulfonic acid, carboxy, C₁₋₆ alkyl carboxy, amino, sulfonic acid C₁₋₆ alkyl, preferably sulfonic acid ethyl or sulfonic acid propyl, more preferably sulfonic acid propyl. Thus, one or both cyclopentadienyl ring systems may e.g. be substituted by one or two, preferably one, sulfonic acid propyl (propylsulfonic acid) substituent. The alkyl linker may advantageously sterically separate the ferrocene ring system and the terminal sulfonic acid group and simplify the synthesis.

In another embodiment, the catholyte as the component of the second redox electrolyte composition may be selected from a Fe complex with one, two or three bipyridyl ligands. In case of one or two bipyridyl ligand(s), the other ligands are preferably selected from cyano (CN). In case of one bipyridyl ligands four cyano ligands may occur, in case of two bipyridyl ligands two cyano ligands may occur. The bipyridyl ligands may be preferably unsubstituted or substituted, typically by one or two substituents. Preferred substituents are C₁₋₆ alkyl carboxy, C₁₋₆ alkyl sulfonic acid, sulfonic acid or carboxy, more preferably sulfonic acid or carboxy. In case of two substituents, they may be preferably positioned mirror-symmetrically at the pyridyl ring systems of the bipyridyl ring system.

By a preferred embodiment, the second electrolyte composition, i.e. the catholyte may contain a salt of Fe(CN)₆³⁻, Fe(CN)₆⁴⁻ and/or combinations as the first redox active species (preferably as the low redox potential species) and a (substituted) bipyridyl iron complex as disclosed herein as a second redox-active species, preferably as the high redox potential species). In another preferred embodiment, the second electrolyte composition contains a salt of Fe(CN)₆³⁻, Fe(CN)₆⁴⁻ and/or combinations as the first redox active species (preferably as the high redox potential species) and a (substituted) ferrocene as disclosed herein as a second redox-active species, preferably as a low redox potential species). Both embodiments may be preferably combined with PANI or MnO as the energy storage material. More preferably, the embodiment employing bipyridyl complexes as a second redox-active species is combined with MnO as the energy storing material. The embodiment employing (substituted) ferrocene as the second redox-active species is combined with PANI (polyaniline) as energy storage material.

Redox flow batteries typically comprise two parallel electrodes separated by a suitable separator, such as an ion exchange membrane, forming two half-cells. Preferably, redox flow batteries according to the invention thus comprise (1) a first half-cell comprising a first or negative electrode contacting a first electrolyte; (2) a second half-cell comprising a second or positive electrode contacting a second electrolyte; and (3) a separator (or “barrier”) disposed between the first and second electrolytes. The electrolyte, which is in contact with the negative electrode, may also be referred to as the “negolyte”. The electrolyte, which is in contact with the positive electrode, may also be referred to as the “posolyte”.

The negative electrode reservoir (“negolyte chamber”) comprises the negative electrode immersed within the negative electrode electrolyte in a container and forms a first redox flow battery half-cell; and the positive electrode chamber (“posolyte chamber”) comprises the positive electrode immersed within the positive electrode electrolyte in a container and forms the second redox flow battery half-cell. Each container and its associated electrode and electrolyte solution thus defines its corresponding redox flow battery half-cell. The containers of each redox flow battery half-cell may be composed of any preferably chemically inert material suitable to retain the respective electrolyte solutions. Each electrolyte preferably flows through its corresponding redox flow battery half-cell flow so as to contact the respective electrode disposed within the electrolyte, and the separator. The electrochemical redox reactions of the employed electrolytes occur within the redox flow battery half-cells.

The posolyte and negolyte chamber defining the corresponding redox flow battery half-cells are preferably connected to a power source. Further, each chamber may be connected, preferably via suitable ducts, to at least one separate storage tank comprising the respective electrolyte solution flowing through said chamber. The insoluble energy storage material of the composition of the present invention is preferably contained in such a storage tank. The storage tank volume determines the quantity of energy stored in the system. The ducts preferably comprise transportation means (e.g. pumps, openings, valves, ducts, tubing) for transporting the electrolyte solutions from the storage tanks through the corresponding half-cell chamber.

The redox flow battery may comprise a first half-cell comprising a composition as an electrolyte as described herein containing at least two redox active species and at least one energy storage material. The second half-cell reflects an aqueous electrolyte as well. The second half-cell may or may not contain an energy storage material. The second half-cell may contain one or more redox active species. In a preferred embodiment, the second half-cell may—as the first half-cell—contain at least two redox active species and at least one energy storage material. Thus both half-cells may contain compositions as defined herein containing at least two redox-active species RAC1/RAC2 and at least one energy storage material. Thus, the present invention discloses a half cell containing a composition as defined herein for use as a catholyte or cathode and a half-cell containing a composition as defined herein for use as an anolyte or anode. A redox flow battery comprising a cathodic half-cell and an anodic half-cell as defined herein (i.e. with each half-cell containing an electrolyte containing at least two redox active species and at least one energy storage support material) is a preferred embodiment of a redox flow battery as disclosed herein.

The half-cell containing the anolyte (negolyte) preferably contains an organic energy storage material as disclosed herein, e.g. an organic polymer compound. The half-cell containing the catholyte (posolyte) does not contain any energy storage material or, preferably, an organic (e.g. PANI) or an inorganic energy storage material as disclosed herein, e.g. MnO. The at least two redox-active species of the electrolyte composition representing the anolyte (anodic half-cell) are preferably of organic nature, in particular phenazine and/or anthraquinone derivatives, preferably as disclosed herein. The redox-active species of the electrolyte composition representing the catholyte (cathodic half-cell) are preferably of inorganic nature, in particular as disclosed herein, e.g. iron complexes (e.g. iron hexacyanoferrate, ferrocene derivatives or bipyridyl iron complexes).

The redox flow battery cell may further comprise control software, hardware, and optional safety systems such as sensors, mitigation equipment, meters, alarms, wires, circuits, switches, signal filters, computers, microprocessors, control software, power supplies, load banks, data recording equipment, power conversion equipment, and other devices and other electronic/hardware controls and safeguards to ensure safe, autonomous, and efficient operation of the redox flow battery. Such systems are known to those of ordinary skill in the art.

Typically, the first redox flow battery half-cell is separated from the second redox flow battery half-cell by a separator (also referred to as a “membrane” or “barrier” herein). Said separator preferably functions to (1) (substantially) prevent mixing of first and second electrolyte, i.e. physically separates the posolyte and negolyte from each other; (2) reduces or prevents short circuits between the positive and negative electrodes; and (3) enables ion (typically H⁺) transport between the positive and negative electrolyte chambers, thereby balancing electron transport during charge and discharge cycles. The electrons are primarily transported to and from an electrolyte through the electrode contacting that electrolyte.

Suitable separator materials may be chosen by the skilled artisan from separator materials known in the art as long as they are (electro-)chemically inert and do not, for example, dissolve in the solvent or electrolyte. Separators are preferably cation-permeable, .e. allow the passage of cations such as H⁺ (or alkali ions, such as sodium or potassium), but is at least partially impermeable to the redox active compounds. The separator may for instance be selected from an ion conducting membrane or a size exclusion membrane.

Separators are generally categorized as either solid or porous. Solid separators may comprise an ion-exchange membrane, wherein an ionomer facilitates mobile ion transport through the body of the polymer which constitutes the membrane. The facility with which ions conduct through the membrane can be characterized by a resistance, typically an area resistance in units of ohm-cm². The area resistance is a function of inherent membrane conductivity and the membrane thickness. Thin membranes are desirable to reduce inefficiencies incurred by ion conduction and therefore can serve to increase voltage efficiency of the redox flow battery cell. Active material crossover rates are also a function of membrane thickness, and typically decrease with increasing membrane thickness. Crossover represents a current efficiency loss that must be balanced with the voltage efficiency gains by utilizing a thin membrane.

Such ion-exchange membranes may also comprise or consist of membranes, which are sometimes referred to as polymer electrolyte membranes (PEMs) or ion conductive membranes (ICMs). The membranes according to the present disclosure may comprise any suitable polymer, typically an ion exchange resin, for example comprising a polymeric anion or cation exchange membrane, or combination thereof. The mobile phase of such a membrane may comprise, and/or is responsible for the primary or preferential transport (during operation of the battery) of at least one mono-, di-, tri-, or higher valent cation and/or mono-, di-, tri-, or higher valent anion, other than protons or hydroxide ions.

Additionally, substantially non-fluorinated membranes that are modified with sulfonic acid groups (or cation exchanged sulfonate groups) may also be used. Such membranes include those with substantially aromatic backbones, e.g., poly-styrene, polyphenylene, bi-phenyl sulfone (BPSH), or thermoplastics such as polyetherketones or polyethersulfones. Examples of ion-exchange membranes comprise NAFION®.

Porous separators may be non-conductive membranes that allow charge transfer between two electrodes via open channels filled with conductive electrolyte solution. Porous membranes are typically permeable to liquid or gaseous chemicals. This permeability increases the probability of chemicals (e.g. electrolytes) passing through porous membrane from one electrode to another causing cross-contamination and/or reduction in cell energy efficiency. The degree of this cross-contamination depends on, among other features, the size (the effective diameter and channel length), and character (hydrophobicity/hydrophilicity) of the pores, the nature of the electrolyte, and the degree of wetting between the pores and the electrolyte solution. Because they contain no inherent ionic conduction capability, such membranes are typically impregnated with additives in order to function. These membranes are typically comprised of a mixture of a polymer, and inorganic filler, and open porosity. Suitable polymers include those chemically compatible with the electrolytes and electrolyte solutions described herein, including high density polyethylene, polypropylene, polyvinylidene difluoride (PVDF), or polytetrafluoroethylene (PTFE). Suitable inorganic fillers include silicon carbide matrix material, titanium dioxide, silicon dioxide, zinc phosphide, and ceria and the structures may be supported internally with a substantially non-ionomeric structure, including mesh structures such as are known for this purpose in the art.

Separators may feature a thickness of about 500 microns or less, about 300 microns or less, about 250 microns or less, about 200 microns or less, about 100 microns or less, about 75 microns or less, about 50 microns or less, about 30 microns or less, about 25 microns or less, about 20 microns or less, about 15 microns or less, or about 10 microns or less, for example to about 5 microns.

The negative and positive electrodes of the inventive redox flow battery provide a surface for electrochemical reactions during charge and discharge. As used herein, the terms “negative electrode” and “positive electrode” are electrodes defined with respect to one another, such that the negative electrode operates or is designed or intended to operate at a potential more negative than the positive electrode (and vice versa), independent of the actual potentials at which they operate, in both charging and discharging cycles. The negative electrode may or may not actually operate or be designed or intended to operate at a negative potential relative to the reversible hydrogen electrode. The negative electrode is associated with the first aqueous electrolyte and the positive electrode is associated with the second electrolyte, as described herein.

The inventive redox flow battery comprises a first (positive) and second (negative) electrode (cathode and anode, respectively).

The negative and positive electrodes of the inventive redox flow battery provide a surface for electrochemical reactions during charge and discharge. The first and second electrode may comprise or consist of the same or a different material(s).

Suitable electrode materials may be selected from any electrically conductive material that is chemically and electrochemically stable (i.e., inert) under the desired operating conditions. Electrodes may comprise more than one material as long as their surface is preferably covered by an electrically conductive and (electro)chemically inert material.

Exemplary electrode materials for use in the inventive redox flow battery may be selected, without limitation, from a metal, such as titanium, platinum, copper, aluminum, nickel or stainless steel; preferably a carbon material, such as glassy carbon, carbon black, activated carbon, amorphous carbon, graphite, graphene, carbon mesh, carbon paper, carbon felt, carbon foam, carbon cloth, carbon paper, or carbon nanotubes; and an electroconductive polymer; or a combination thereof. The term “carbon material” refers to materials which are primarily composed of the element carbon, and typically further contain other elements, such as hydrogen, sulfur, oxygen, and nitrogen. Carbon materials containing a high surface area carbon may be preferred due to their capability of improving the efficiency of charge transfer at the electrode.

The electrodes may take the form of a plate, which may preferably exhibit an increased surface area, such as a perforation plate, a wave plate, a mesh, a surface-roughened plate, a sintered porous body, and the like. Electrodes also may be formed by applying any suitable electrode material onto the separator.

The present invention also provides a method for storing energy by charging a redox flow battery as disclosed herein. Alternatively, the present invention discloses a method providing energy by discharging a redox flow battery as disclosed herein.

The following Examples shall further illustrate the present invention.

### EXAMPLES

### General Information

2-Hydroxy-1,4-naphthoquinone (Lawsone, >98%, TCl) was commercially purchased and used in flow cell experiments.

The synthesis of the following compounds was carried out as follows: 7,8-Dihydroxy-2-phenazinesulfonic acid (DHPS) [WO 2020/035138 A1], poly(neutral red) [S. Z. Ozkan, G. P. Karpacheva, Y. G. Kolyagin, Polymer Bulletin 2019, 76, 5285.].

### Preparation of N,N′-diphenyl-1,4,5,8-naphthalenetetracarboxylic diimide (DPNTCDI)

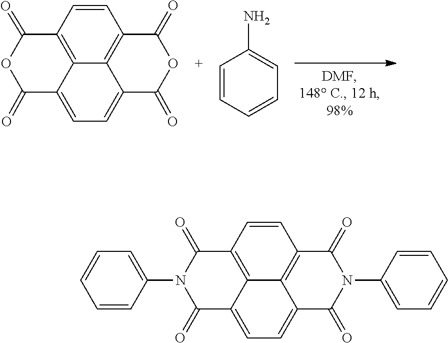

The synthetic procedure is described by [J. A. Alatorre Barajas, ChemistrySelect 2018, 3, 11943.] and was adapted as follows: 1,4,5,8-Naphthalenetetracarboxylic dianhydride (3.27 g, 12.2 mmol) was dissolved in dimethylformamide (33 mL) and aniline (2.27 g, 24 mmol) was added. The stirred reaction mixture was heated to 125° C. and dimethylformamide (100 mL) was added upon precipitation. The reaction mixture was heated up to 148° C. for 12 hours. The reaction mixture was cooled to 80° C. and the precipitated product was isolated by filtration and washed with aqueous sodium carbonate solution (10% w/w, 30 mL), hydrochloric acid (10% w/w, 30 mL) and methanol (up to 10 mL). N,N′-diphenyl-1,4,5,8-naphthalenetetracarboxylic diimide (DPNTCDI, 5.75 g, 11.9 mmol, 98%) was obtained as a light yellow solid in 98% yield.

Preparation of Ethylene Bridged Polyimide (ePNTCDI)

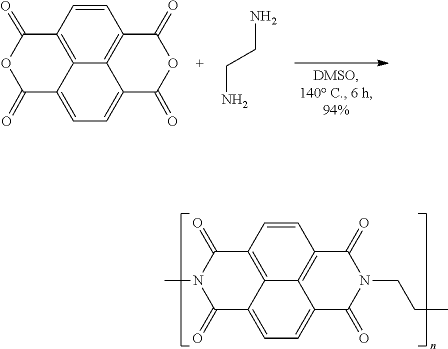

A 500 mL four-necked round bottom flask equipped with a mechanical stirrer, a reflux condenser, and a temperature probe was filled with DMSO (215 mL). 1,4,5,8-Naphthalenetetracarboxylic dianhydride (NTCDA, 8.36 g, 30.0 mmol) was added and an off-white suspension was obtained. The mixture was heated with mechanical stirring to 140° C. At this temperature, a solution formed and a solution of 1,2-diaminoethane (DAE, 2.02 mL, 1.82 g, 30.0 mmol) in DMSO (28 mL) was added dropwise via a dropping funnel within 30 minutes. An orange precipitate formed. After the addition was completed, the reaction mixture was stirred at 140° C. for 6 h with mechanical stirring. The mixture was cooled to 25° C. and stirred for additional 16 h. The mixture was filtered and the solid was washed with DMSO (1×30 ml) and ethanol (3×30 mL). After drying at 60° C., the desired polyimide (ePNTCDI, 8.77 g, in relation to the mass of a 1:1-adduct of NTCDA and DAE: 28.1 mmol, 94%) was obtained as an orange solid.

### Processing of Solid Energy Storage Materials for Use in Redox-Targeting Redox-Flow Batteries

For use in redox-targeting redox-flow batteries, the solid energy storage materials were processed with carbon black (CB, PBX 135 from Cabot) and/or multi-walled carbon nanotubes (MWCNTs, NC7000 from Nanocyl) and a 1 wt % polyvinylidene difluoride (PVDF, Kynar Flex ADX 2250-05E from Kynar) solution in methylethylketone (MEK, 99.5% by Roth). In a typical procedure, the solid energy storage material (1.0 g) was mixed with CB (0.2 g) and MWCNTs (0.1 g). Coarse mixtures were finely ground in a mortar. The homogenized powder was suspended in the 1 wt % PVDF-solution in MEK (20 g) and stirred vigorously for a short time. The MEK was then removed under reduced pressure. The dry solid was coarse-ground and pressed into plates of 4×4 cm at 100 to 120° C. using a temperature-controlled hydraulic press applying 5 bar of pressure. The plates were cut into pieces of approximately 1 cm² and transferred into pouches of approximately 3×8 cm (polyester mesh, mesh size 15 μm) which were then sealed using a heat welder.

The exact compositions of the processed solid energy storage materials are listed in the following Table I:

| Used solid | | | | Resulting portion |
|---|---|---|---|---|
| energy storage | Amount of | | Amount of | of solid energy |
| material | carbon | Amount of | PVDF- | storage material |
| (purity [%]), | black | MWCNTs | binder (dry) | after processing |
| amount [g] | [g] | [g] | [g] | [%] |
| poly(neutral | 0.20 | 0.10 | 0.20 | 62 |
| red) | | | | |
| (>99), 0.80 | | | | |
| DPNTCDI | 0.37 | 0.19 | 0.37 | 67 |
| (>99), 1.85 | | | | |
| ePNTCDI | 1.00 | 0.24 | 0.55 | 53 |
| (>99), 2.00 | | | | |

### Flow Cell Experiments

For electrochemical characterization, a small laboratory cell was used. A graphite felt (with an area of 6 cm², 6 mm in thickness, supplier: SGL Sigracell GFA 6EA) in combination with a bipolar plate (4.1 cm×4.1 cm, SGL Sigracell TF6) was employed as both the positive and negative electrode. A cation exchange membrane (620PE, supplier: fumatech) was used to separate the positive and negative electrolytes. The membrane was conditioned in an aqueous KOH/NaOH 1:1 solution (0.5 M) for at least 72 h prior to each test. As anolyte, 35 mL of a solution of DHPS (RAC1, 0.094 M), Lawsone (RAC2, 0.021 M) and KOH/NaOH (1:1-mixture, 0.96 M) in H₂O was used for every experiment. The catholyte consisted of K₄[Fe(CN)₆]/Na₄[Fe(CN)₆] (1:1-mixture, 0.36 M) and KOH/NaOH (1:1-mixture, 0.69 M) in H₂O and was employed in stoichiometric excess in order to obtain charge limitation solely due to the anolyte materials. Both electrolytes were pumped by peristaltic pumps (Drifton BT100-1L, Cole Parmer Ismatec MCP and BVP Process IP 65) at a rate of 24 mL/min to the corresponding electrodes, respectively. The electrolyte reservoirs were purged with N₂ gas for 1 h before start of charging and the inert atmosphere was maintained during the course of the experiments.

Electrochemical testing was performed on a BaSyTec (BaSyTec GmbH. 89176 Asselfingen. Germany) or a Bio-Logic (Bio-Logic Science Instruments. Seyssinet-pariset 38170. France) battery test system. For cycling, the cell was charged galvanostatically at a current density of 20 mA/cm² up to 1.6 V and discharged at the same current density down to 0.5 V cut-off. Potentiostatic holds at the voltage limits with <1.5 mA/cm² current limitation were used in order to get maximum electrolyte exploitation and to neglect small changes e.g. in membrane resistance.

Before addition of each processed solid energy storage material (in a polyester pouch), the cell was cycled for 3 full cycles to obtain the electrochemical parameters of the specific combination of RAC solutions.

The obtained experimental results are listed in the following Table II:

| | | | | | Increase in |
|---|---|---|---|---|---|
| | | | | Gravimetric | gravimetric energy |
| | Processed | | | energy density | density per kg of |
| | Energy storage | Catholyte | Round-trip- | of anolyte | pure solid energy |
| Anolyte | material used, | volume | efficiency | solution | storage material |
| composition | mass [g] | [mL] | [%] | [Wh/kg]^{a, b} | [Wh/kg]^{b} |
| DHPS, | / | 50 | 81 | 8.3 | / |
| Lawsone, | | | | | |
| KOH/NaOH | | | | | |
| (1:1) | | | | | |
| DHPS, | poly(neutral | 50 | 69 | 8.7 | 112.9 |
| Lawsone, | red), 1.11 | | | | |
| KOH/NaOH | | | | | |
| (1:1) | | | | | |
| DHPS, | DPNTCDI, | 50 | 73 | 8.4 | 77.9 |
| Lawsone, | 1.17 | | | | |
| KOH/NaOH | | | | | |
| (1:1) | | | | | |
| DHPS, | ePNTCDI, | 58 | 81 | 13.1 | 122.1 |
| Lawsone, | 1.20 | | | | |
| KOH/NaOH | | | | | |
| (1:1) | | | | | |

^{a}density of a solution of DHPS (0.094M), Lawsone (0.021M) and KOH/NaOH 1:1 (0.96M) in H₂O is 1.076 g/mL.;
^{b}energy values were obtained by evaluation of the recorded data using BT-Lab ® Software V.1.57.

### Further Experiments

Further experiments based on the above experimental set-up have been carried with other anolytes (RAC1/RAC2) in combination with various solid energy storage materials (IESM). The experimental conditions correspond to those described above. The “experimental capacity increase” mirrors the experimentally determined amount (%) of energy storage material involved in charge storage—upon addition of the energy storage material to the electrolyte solution—based on the theoretical maximum charge storage capacity (100%) as a reference value, typically for the third cycle upon addition of the the energy storage material.
A. Tetraazapentacene (TAP) as energy storage material is combined with the anolytes (i) DHPS/Lawsone and (ii) DHPS/Alizarin red S (3,4-dihydroxy-9,10-dioxo-2-anthracensulfonic acid or a salt, typically a sodium salt thereof).
   Tetraazapentacene (TAP) as energy storage material (IESM) corresponds to the following structural formula

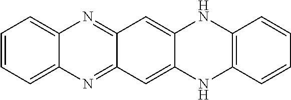 [SMILES: c1ccc2c(c1)Nc1cc3nc4ccccc4nc3cc1N2]

Synthesis of TAP was carried out according to the description by Chem. Commun. 2010, 46, 2977-2979; S. A. Jenekhe, Macromolecules, 24, 1-10 (1991) or C. Seillan, H. Brisset, and O. Siri, Organic Letters, 10, 4013-4016 (2008).
Table III summarizes the concentrations of each component, the theoretical capacity of RAC1+RAC2 and of the employed IESM and the experimentally measured capacity increase upon addition of the IESM:

| | | | theor. | | |
|---|---|---|---|---|---|
| | | NaOH/ | capacity | theor. | exp. |
| RAC1 | RAC2 | KOH | RAC1 + | capacity | capacity |
| (conc.) | (conc.) | (1:1) (conc.) | RAC2 | IESM | increase |
| DHPS | Lawsone | 1.01M | 313 mAh | 154 mAh | 64% |
| (100 mM) | (30 mM) | | | | |
| DHPS | Alizarin | 0.7M | 300 mAh | 148 mAh | 62% |
| (110 mM) | red S | | | | |
| | (40 mM) | | | | |

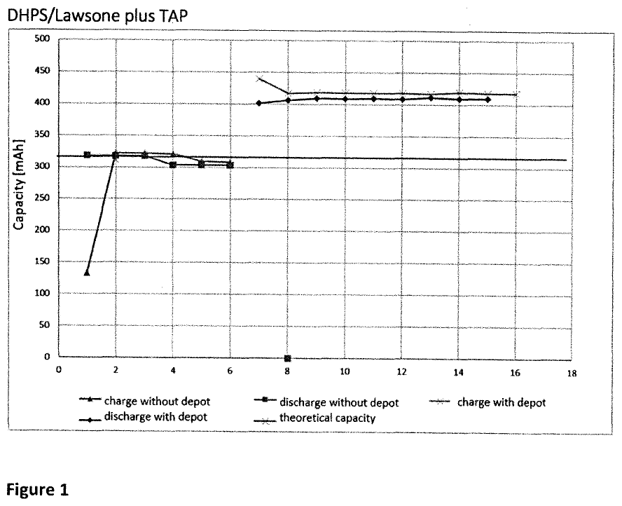

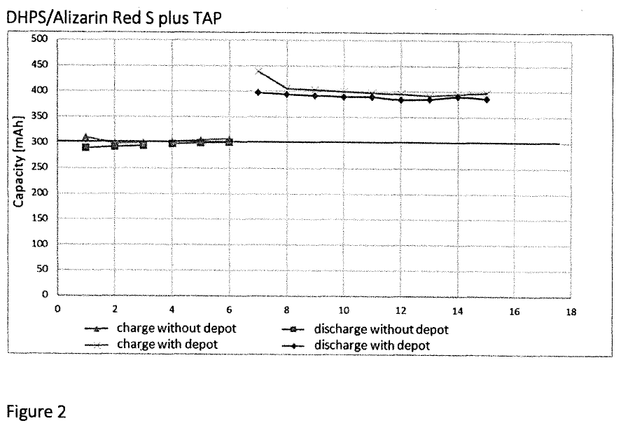

FIGS. 1 to 2 present the amount of charge measured for each of the above experiments for each cycle. In Figure X, the first cycle with IESM is cycle 7, in Figure Y, cycle 6.
B. Poly-ortho-Phenylendiamine (pOPD) as energy storage material is combined with (i) DHPS/Lawsone and (ii) DHP (2,3-dihydroxyphenazine)/Lawsone.
   Poly-ortho-Phenylendiamine (pOPD) as IESM corresponds to the following structural formula

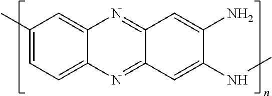

Synthesis pf pOPD was carried out according to European Polymer Journal, Volume 32, Issue 1, January 1996, pp. 43-50.

TABLE IV

| | | | theor. | | |
|---|---|---|---|---|---|
| | | NaOH/ | capacity | theor. | exp. |
| RAC1 | RAC2 | KOH | RAC1 + | capacity | capacity |
| (conc.) | (conc.) | (1:1) (conc.) | RAC2 | IESM | increase |
| DHPS | Lawsone | 1.01M | 313 mAh | 154 mAh | 65% |
| (100 mM) | (30 mM) | | | | |
| DHP | Lawsone | 1.02M | 311 mAh | 150 mAh | 43% |
| (100 mM) | (30 mM) | | | | |

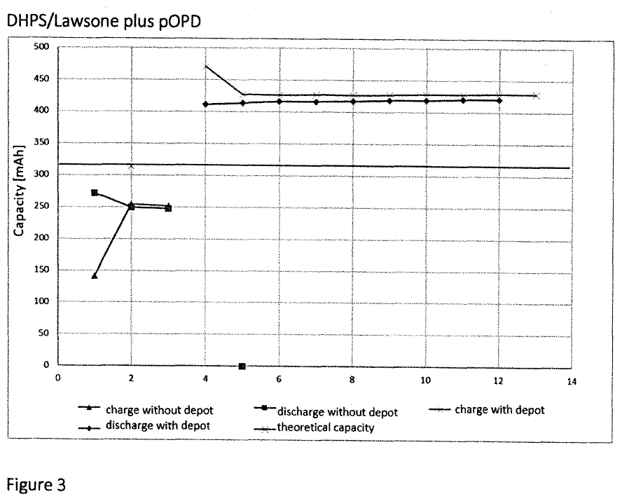

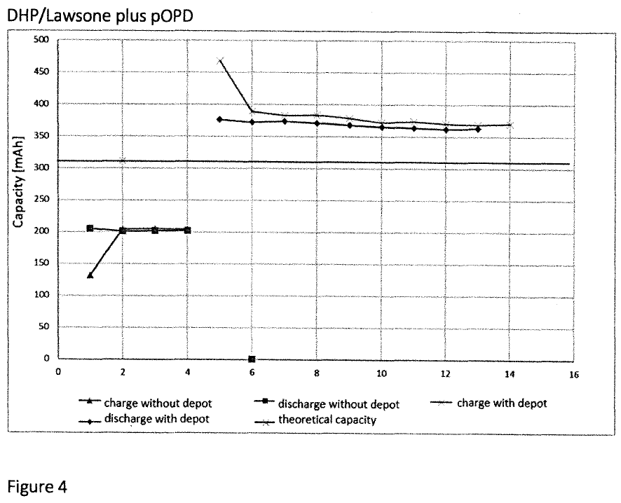

FIGS. 3 to 4 present the amount of charge for measure for each cycle, with cycle 4 being the first cycle involving IESM.
C. 2,3-Diaminophenazine (DAP) as energy storage material is combined with DHPS/Lawsone.
   2,3-Diaminophenazine (DAP) corresponds to the following structural formula:

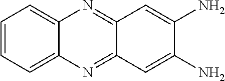 [SMILES: Nc1cc2nc3ccccc3nc2cc1N]

Its synthesis has been carried out according to J. Mol. Struct., 2014, 1062, 44-47.

TABLE VI

| | | | theor. | | |
|---|---|---|---|---|---|
| | | NaOH/ | capacity | theor. | exp. |
| RAC1 | RAC2 | KOH | RAC1 + | capacity | capacity |
| (conc.) | (conc.) | (1:1) (conc.) | RAC2 | IESM | increase |
| DHPS | Lawsone | 1.01M | 244 mAh | 122 mAh | 37% |
| (100 mM) | (30 mM) | | | | |

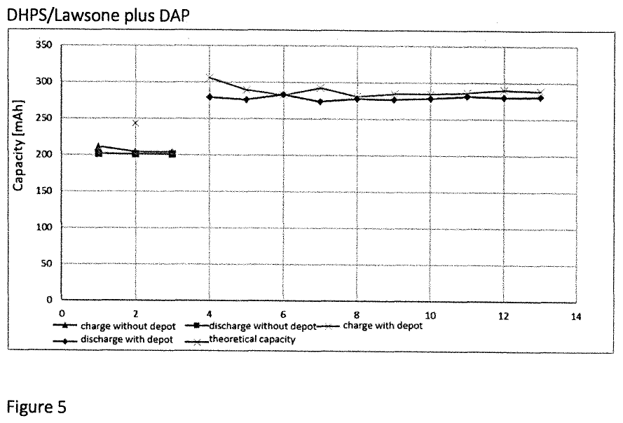

FIG. 5 presents the amount of charge measured for each cycle, with cycle 4 being the first cycle involving IESM.
D. Trimethylquinoxaline (TMeQ) as energy storage material is combined with (i) DHPS/Lawsone, and (ii) Quin-COOH (quinoxaline-2-yl)acetic acid)/Lawsone
   Trimethylquinoxaline (TMeQ) corresponds to the following structural formula:

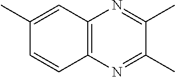

Its synthesis was carried out according to Transition Metal Chemistry (Dordrecht, Netherlands) (2010), 35(1), 49-53.

TABLE VII

| | | | theor. | | |
|---|---|---|---|---|---|
| | | NaOH/ | capacity | theor. | exp. |
| RAC1 | RAC2 | KOH | RAC1 + | capacity | capacity |
| (conc.) | (conc.) | (1:1) (conc.) | RAC2 | IESM | increase |
| DHPS | Lawsone | 1.01M | 244 mAh | 147 mAh | 60% |
| (100 mM) | (30 mM) | | | | |
| Quin-COOH | Lawsone | 0.4M | 244 mAh | 159 mAh | 53% |
| (100 mM) | (30 mM) | | | | |

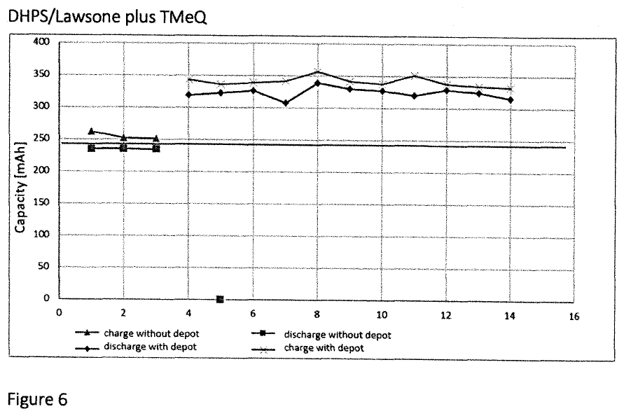

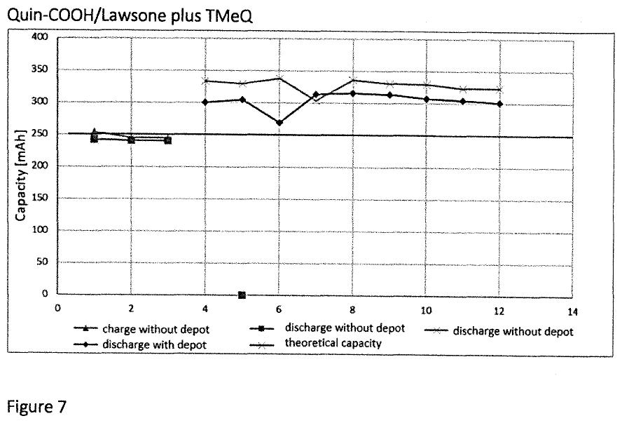

FIGS. 6 to 7 present the amount of charge measured for each cycle, with cycle 4 being the first cycle involving IESM.
E. Dimethylquinoxaline (DMeQ) as energy storage material is combined with DHPS/Lawsone
   Dimethylquinoxaline (DMeQ) corresponds to the structural formula:

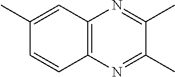

Its synthesis was carried out according to Transition Metal Chemistry (Dordrecht, Netherlands) (2010), 35(1), 49-53.

TABLE VIII

| | | | theor. | | |
|---|---|---|---|---|---|
| | | NaOH/ | capacity | theor. | exp. |
| RAC1 | RAC2 | KOH | RAC1 + | capacity | capacity |
| (conc.) | (conc.) | (1:1) (conc.) | RAC2 | IESM | increase |
| DHPS | Lawsone | 1.01M | 313 mAh | 149 mAh | 55% |
| (100 mM) | (30 mM) | | | | |

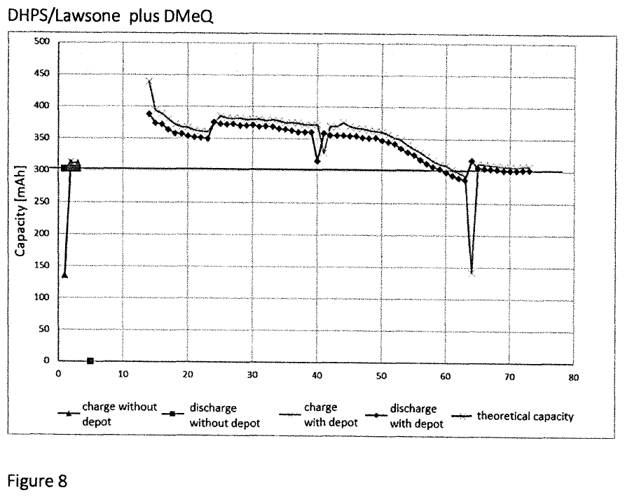

FIG. 8 presents the amount of charge measured for each cycle, with cycle 14 being the first cycle involving IESM.

In addition, the following experiments F. und G. for catholytes (posolytes) were carried out based on the following experimental set-up.

For the examples shown for posolytes 35 mL-45 ml of a catholyte solution of an electrolyte mixture consisting of RAC1 and RAC2 (concentrations shown in tables) and a salt (salt and concentrations shown in tables) were used. As anolyte a solution of 2,7-anthraquinonesulfonic acid (0.2 M in 1 M H₂SO₄) was used in acidic cells and a mixture of [Fe(CN)₆]³⁺/[Fe(CN)₆]⁴⁺ (Na/K=1:1-mixture, 0.2-0.65 M catholyte) in neutral cells. The osmotic pressure of both solutions was balanced. The anolytes were employed in stoichiometric excess in order to obtain charge limitation solely due to the catholyte materials.

Both electrolytes were pumped by peristaltic pumps (Drifton BT100-1L, Cole Parmer Ismatec MCP and BVP Process IP 65) at a rate of 24 mL/min to the corresponding electrodes, respectively. The electrolyte reservoirs were purged with N₂ gas for 1 h before start of charging and the inert atmosphere was maintained during the course of the experiments.

Electrochemical testing was performed on a BaSyTec (BaSyTec GmbH. 89176 Asselfingen Germany) or a Bio-Logic (Bio-Logic Science Instruments. Seyssinet-pariset 38170. France) battery test system. For cycling, the cell was charged galvanostatically at a current density of 20 mA/cm² up to 1.6 V and discharged at the same current density down to 0.5 V cut-off. Potentiostatic holds at the voltage limits with <1.5 mA/cm² current limitation were used in order to get maximum electrolyte exploitation and to neglect small changes e.g. in membrane resistance.

Before addition of each processed solid energy storage material (in a polyester pouch), the cell was cycled for 3 full cycles to obtain the electrochemical parameters of the specific combination of RAC solutions.
F. Polyaniline (PANI) as energy storage material is combined with 1,4-dihydroxybenzene-2-sulfonic acid (Bulli01-Mono) and 1,4-dihydroxybenzene-2,5-disulfonic acid (Bulli01-Di)
   Polyaniline corresponds to the following structural formula:

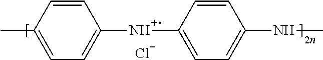

It was synthesized according to Catal. Sci. Technol., 2019, 9, 753-761.

TABLE IX

| | | | theor. | | |
|---|---|---|---|---|---|
| | | | capacity | theor. | exp. |
| RAC1 | RAC2 | H₂SO₄ | RAC1 + | capacity | capacity |
| (conc.) | (conc.) | (conc.) | RAC2 | IESM | increase |
| Bulli01- | Bulli01-Di | 1M | 234 mAh | 108 mAh | 40% |
| Mono | (250 mM) | | | | |
| (100 mM) | | | | | |

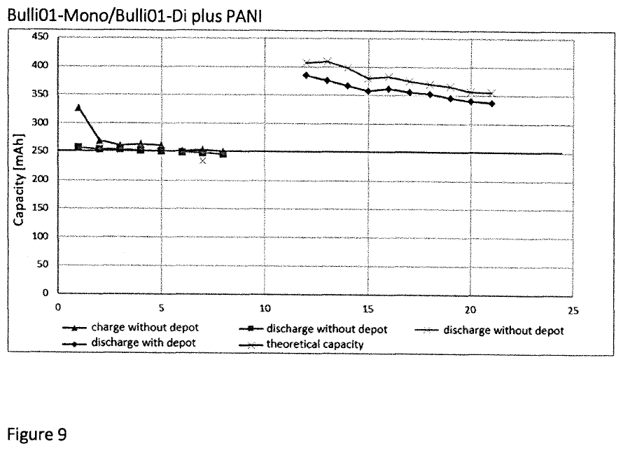

FIG. 9 presents the amount of charge measured for each cycle, with cycle 12 being the first cycle involving IESM.
G. Prussian Blue (PB) as energy storage material is combined with FAT (K₄[Fe(CN)₆]/Na₄[Fe(CN)₆] (1:1-mixture) and BiPy-FAT (Na₄[Fe^{II}(Dcbpy)₃]) (Dcbpy: 2,2′-bipyridyl-4,4′-dicarboxylic acid)

Prussian Blue corresponds to Fe₄[Fe(CN)₆]₃ (Chen, Y., Wang, Q. et al., Joule 2019, 3, 2255-2226)

TABLE X

| | | | theor. | | |
|---|---|---|---|---|---|
| | | | capacity | theor. | exp. |
| RAC1 | RAC2 | KCl | RAC1 + | capacity | capacity |
| (conc.) | (conc.) | (conc.) | RAC2 | IESM | increase |
| FAT | BiPy-FAT | 1M | 127 mAh | 148 mAh | 32% |
| (100 mM) | (50 mM) | | | | |

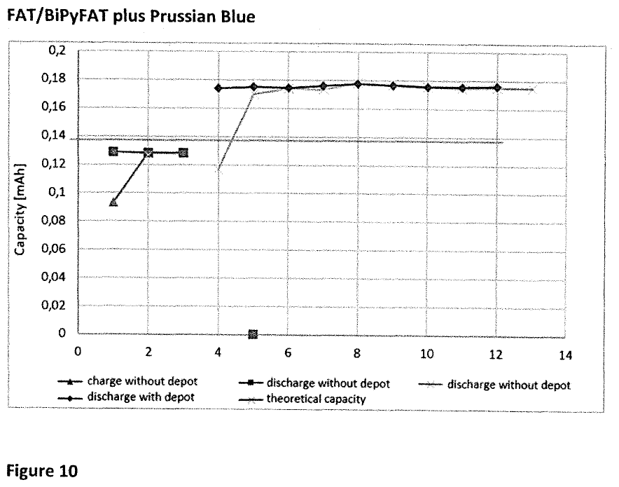

FIG. 10 presents the amount of charge measured for each cycle, with cycle 4 being the first cycle involving IESM.

Finally, additional experiments with a cell was carried out. The first half-cell was filled with an excess of anolyte (negolyte (45 ml): DHPS in aqueous solution mixed with 20% (by volume) of DMSO and 0.4 M LiOH (capacity 964,88 mAh). The second half-cell was filled with posolyte. The posolyte was FAT (1:1-mixture K₄[Fe(CN)₆]/Na₄[Fe(CN)₆]) dissolved in the same solution of water and DMSO with 0.4 M LiOH (capacity 578.88 mAh). Polarization was carried out and 6 cycles with 120 mA (1.0-1.6 V) were carried out with subsequent discharging. The energy storage material (LiFe phosphate) was added thereafter into the posolyte container. Additional 7 cycles were carried out.

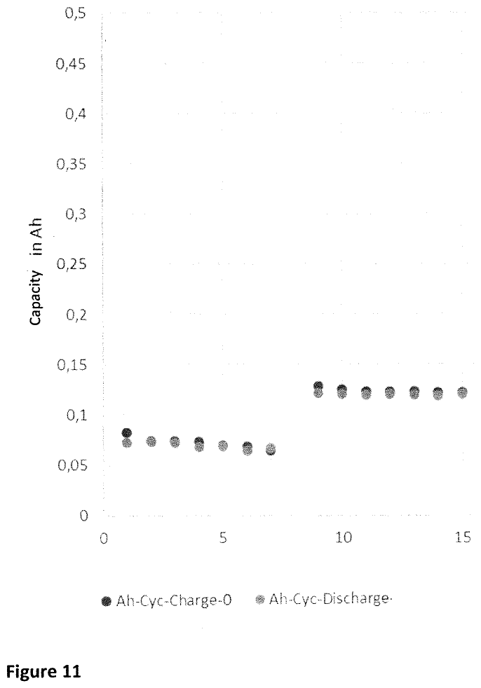

The results are shown in FIG. 11. 38.4% of the energy storage material is used at cycle 9 (3^{rd} cycle together with the energy storage material).

1. A composition comprising an aqueous solution of at least two redox-active compounds RAC1 and RAC2 and at least one insoluble energy storage material; wherein the redox potential of RAC1 is more negative than the redox potential of the insoluble energy storage material, and the redox potential of RAC2 is more positive than the redox potential of the insoluble energy storage material; and wherein the difference of the redox potentials of RAC1 and RAC2 is at least 50 mV.

2. The composition according to claim 1, wherein the at least one insoluble energy storage material is an insoluble organic or inorganic energy storage material.

3. The composition according to claim 1, wherein the difference of the redox potentials of RAC1 and the insoluble (organic) energy storage material is at least 25 mV.

4. The composition according to claim 1, wherein the difference of the redox potentials of RAC2 and the insoluble (organic) energy storage material is at least 25 mV.

5. The composition according to claim 1, wherein the difference of the redox potentials of RAC1 and RAC2 is less than 500 mV.

6. The composition according to claim 1, wherein the concentration of RAC1 in the aqueous solution is at least 0.005 mol/l.

7. The composition according to claim 1, wherein the concentration of RAC1 in the aqueous solution is less than 1 mol/l.

8. The composition according to claim 1, wherein the concentration of RAC2 in the aqueous solution is at least 0.005 mol/l.

9. The composition according to claim 1, wherein the concentration of RAC2 in the aqueous solution is less than 1 mol/l.

10. The composition according to claim 1, wherein the pH value of the aqueous solution is from 7 to 14.

11. The composition according to claim 1, wherein the aqueous solution contains up to 50% (by weight) of an organic co-solvent.

12. The composition according to claim 1, wherein the energy density provided by the insoluble organic or inorganic energy storage material is at least 10, 20, 50 or 100 mWh/g or from 10 to 2000 mWh/g.

13. The composition according to claim 1, wherein the composition is an aqueous composition having a water content of at least 50% (by weight) and wherein RAC1, RAC2 and the energy storage material are reversibly redox-active and do not form irreversible complexes with each other or with water and wherein the energy storage material is configured for storing electrical energy with an energy storage density of at least 10 mWh/g.

14. The composition according to claim 1, wherein at least one of the redox-active compounds is a substituted phenazine derivative.

15. The composition according to claim 1, wherein redox-active compound contains a quinoid system.

16. The composition according to claim 1, wherein redox-active compound is a compound having the following formula: 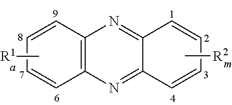
wherein
R¹ and R² are independently selected from C₁₋₅ alkyl, R^{x}OR³, R^{x}SO₃H, R^{x}COOH, R^{x}OM, R^{x}SO₃M, R^{x}COOM, R^{x}NR³₃X, R^{x}NR³₂, R^{x}PO(OH)₂, R^{x}SH, R^{x}PS(OH)₂, R^{x}OPO(OH)₂, R^{x}OPS(OH)₂, R^{x}SPS(OH)₂, and (OCH₂CH₂)ᵣOR³;
each R³ is independently H or C₁₋₅ alkyl;
each R^{x} is independently a bond or C₁₋₅ alkylene;
M is a cation;
X is an anion;
r is 1 or greater;
a is an integer of from 0 to 4;
m is an integer of from 0 to 4; and
the sum of a and m is an integer of from 1 to 8;
or a tautomeric form or a different oxidation state thereof.

17. The composition according to claim 16, wherein
R¹ and R² are independently selected from R^{x}OR³, R^{x}SO₃H, R^{x}COOH, R^{x}OM, R^{x}SO₃M, R^{x}COOM, R^{x}NR³₃X, R^{x}NR³₂, and (OCH₂CH₂)ᵣOR³;
each R³ is independently H or C₁₋₅ alkyl;
each R^{x} is independently a bond or C₁₋₅ alkylene;
M is a cation;
X is an anion;
r is 1 or greater;
a is an integer of from 0 to 4;
m is an integer of from 0 to 4; and
the sum of a and m is an integer of from 1 to 4.

18. The composition according to claim 16, wherein
R¹ and R² are independently selected from R^{x}OR³, R^{x}SO₃H, R^{x}OM, R^{x}SO₃M, R^{x}NH₃X, and R^{x}NH₂;
each R³ is independently H or C₁₋₅ alkyl;
each R^{x} is independently a bond or C₁₋₅ alkylene;
M is a cation;
X is an anion;
a is an integer of from 0 to 2;
m is an integer of from 0 to 2; and
the sum of a and m is an integer of from 1 to 3.

19. The composition according to claim 1, wherein redox-active compound is a compound having the following formula: 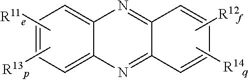
wherein
R¹¹ and R 12 are independently a group of formula —NH—R^{y}—COOH or —NH—R^{y}—COOM;
R¹³ and R¹⁴ are independently selected from C₁₋₅ alkyl, R^{x}OR³, R^{x}SO₃H, R^{x}COOH, R^{x}OM, R^{x}SO₃M, R^{x}COOM, R^{x}NR³₃X, R^{x}NR³₂, R^{x}PO(OH)₂, R^{x}SH, R^{x}PS(OH)₂, R^{x}OPO(OH)₂, R^{x}OPS(OH)₂, R^{x}SPS(OH)₂, and (OCH₂CH₂)ᵣOR³;
each R³ is independently H or C₁₋₅ alkyl;
each R^{x} is independently a bond or C₁₋₅ alkylene;
each R^{y} is independently C₁₋₅ alkylene;
M is a cation;
X is an anion;
r is 1 or greater;
e is an integer of from 1 to 4;
f is an integer of from 1 to 4;
p is an integer of from 0 to 3;
q is an integer of from 0 to 3;
the sum of e and p is an integer of from 1 to 4; and
the sum of f and q is an integer of from 1 to 4;
or a tautomeric form or a different oxidation state thereof.

20. The composition according to claim 19, wherein p and q are both 0.

21. The composition according to claim 19, wherein e and f are both 1.

22. The composition according to claim 19, wherein the redox-active compound is a compound having the following formula: 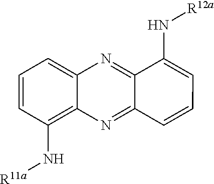
wherein
R^{11a} and R^{12a} are independently a group of formula —R^{y}—COOH or —R^{y}—COOM;
M is a cation; and
each R^{y} is independently C₁₋₅ alkylene;
or a tautomeric form or a different oxidation state thereof.

23. The composition according to claim 19, wherein R^{y} is selected from the following groups: —CH₂—; —CH₂—CH₂—; —CH₂—CH₂—CH₂—; and —CH(CH₃)—.

24. The composition according to claim 1, wherein the redox-active compound is a compound having one of the following formulae: 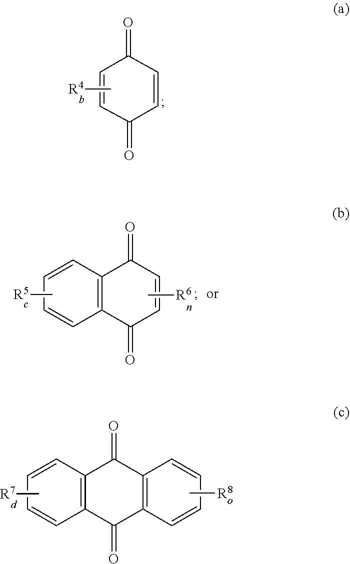
wherein
R⁴, R⁵, R⁶, R⁷ and R⁸ are independently selected from C₁₋₅ alkyl, R^{x}OR³, R^{x}SO₃H, R^{x}COOH, R^{x}OM, R^{x}SO₃M, R^{x}COOM, R^{x}NR³₃X, R^{x}NR³₂, R^{x}PO(OH)₂, R^{x}SH, R^{x}PS(OH)₂, R^{x}OPO(OH)₂, R^{x}OPS(OH)₂, R^{x}SPS(OH)₂, and (OCH₂CH₂)ᵣOR³;
each R³ is independently H or C₁₋₅ alkyl;
each R^{x} is independently a bond or C₁₋₅ alkylene;
M is a cation;
X is an anion;
r is 1 or greater;
b is an integer of from 1 to 4;
c in an integer of from 0 to 4;
d is an integer of from 0 to 4;
n is an integer of from 0 to 2;
o is an integer of from 0 to 4;
the sum of c and n is an integer of from 1 to 6; and
the sum of d and o is an integer of from 1 to 8;
or a tautomeric form or a different oxidation state thereof.

25. The composition according to claim 24, wherein
R⁴, R⁵, R⁶, R⁷ and R⁸ are independently selected from R^{x}OR³, R^{x}SO₃H, R^{x}COOH, R^{x}OM, R^{x}SO₃M, R^{x}COOM, R^{x}NR³₃X, R^{x}NR³₂, and (OCH₂CH₂)ᵣOR³;
each R³ is independently H or C₁₋₅ alkyl;
each R^{x} is independently a bond or C₁₋₅ alkylene;
M is a cation;
X is an anion;
r is 1 or greater;
b is an integer of from 1 to 4;
c in an integer of from 0 to 4;
d is an integer of from 0 to 4;
n is an integer of from 0 to 2;
o is an integer of from 0 to 4;
the sum of c and n is an integer of from 1 to 4; and
the sum of d and o is an integer of from 1 to 4.

26. The composition according to claim 24, wherein
R⁴, R⁵, R⁶, R⁷ and R⁸ are independently selected from R^{x}OR³, R^{x}SO₃H, R^{x}OM, R^{x}SO₃M, R^{x}NR³₃X and R^{x}NR³₂;
each R³ is independently H or C₁₋₅ alkyl;
each R^{x} is independently a bond or C₁₋₅ alkylene;
M is a cation;
X is an anion;
b is an integer of from 1 to 3;
c in an integer of from 0 to 2;
d is an integer of from 0 to 3;
n is an integer of from 0 to 2;
o is an integer of from 0 to 3;
the sum of c and n is an integer of from 1 to 4; and
the sum of d and o is an integer of from 1 to 4.

27. The composition according to claim 16, wherein R^{x} is a bond.

28. The composition according to claim 1, wherein the at least one insoluble organic energy storage material is an organic compound or organic polymer.

29. The composition according to claim 28, wherein the at least one insoluble organic energy storage material is selected from the group consisting of tetraazapentacene (TAP), poly-ortho-phenylenediamine, poly-meta-phenylenediamine, polypoly-para-phenylenediamine, 2,3-diaminophenazine (DAP), trimethylquinoxaline, (TMeQ), dimethylquinoxaline (DMeQ), polyaniline (PANI) Prussian Blue (PB), poly (neutral red), N,N′-diphenyl-1,4,5,8-naphthalenetetracarboxylic diimide, and poly (N-ethyl-naphthalenetetracarboxylic diimide); or a tautomeric form or a different oxidation state thereof.

30. The composition according to claim 29, wherein the at least one insoluble organic energy storage material is selected from the group consisting of poly (neutral red), N,N′-diphenyl-1,4,5,8-naphthalenetetracarboxylic diimide, and poly (N-ethyl-naphthalenetetracarboxylic diimide); or a tautomeric form or a different oxidation state thereof.

31. The composition according to claim 1, wherein the at least one insoluble inorganic energy storage material is selected from the group consisting of a metal salt.

32. The composition according to claim 31, wherein the at least one insoluble inorganic energy storage material is MnO.

33. The composition according to claim 1, wherein the composition contains an optionally substituted bipyridyl iron complex as a redox-active species.

34. The composition according to claim 1, wherein the composition contains a (substituted) ferrocene as a redox-active species.

35. The composition according to claim 1, wherein the composition does not contain any Li.

36. (canceled)

37. (canceled)

38. (canceled)

39. A half-cell of a redox flow battery comprising the composition according to claim 1 and an electrode.

40. The half-cell of the redox flow battery according to claim 39, wherein the composition is an anode.

41. The half-cell of the redox flow battery according to claim 39, wherein the composition is a cathode.

42. (canceled)

43. (canceled)

44. A redox-flow battery comprising the composition according to claim 1.

45. The redox-flow battery according to claim 44, wherein the redox-flow battery comprises an anodic half-cell comprising the composition as an anode and a cathodic half-cell comprising the composition as a cathode.

46. A method for storing energy by charging the redox flow battery according to claim 44.

47. A method for providing energy by discharging the redox flow battery according to claim 44.

48. The composition according to claim 11, wherein the organic co-solvent is methanol, acetonitrile, DMSO, or a mixture thereof.

49. The composition according to claim 15, wherein the quinoid system is a substituted benzoquinone, naphthaquinone, or anthraquinone.

50. The composition according to claim 49, wherein the compound containing the quinoid system is the RAC2 compound.

51. The composition according to claim 31, wherein the metal salt is a metal oxide or a metal hydroxide, and wherein the metal is selected from Fe, Ni, Mn, Co, and Cu.

52. The composition according to claim 51, wherein the metal is Ni or Mn.

53. The composition according to claim 32, wherein the MnO is Birnessite.

54. The composition according to claim 34, wherein the composition contains a (substituted) ferrocene as a redox-active species in combination with a salt of Fe(CN)₆³⁻, Fe(CN)₆⁴⁻ and/or combinations thereof as a second redox-active species.

55. The composition according to claim 54, wherein the composition contains a (substituted) ferrocene as a redox-active species in combination with polyaniline (PANI) as an energy storage material.
